(19) United States
(12) Patent Application Publication
(10) Pub. No.: US 2006/0080505 A1
(43) Pub. Date: Apr. 13, 2006

(54) Disk array device and control method for same

(76) Inventors: Masahiro Arai, Kawasaki (JP); Naoto Matsunami, Hayama (JP); Junji Ogawa, Yokohama (JP)

Correspondence Address: MATTINGLY, STANGER & MALUR, P.C.;ATTORNEYS AT LAW, SUITE 370, 1800 DIAGONAL ROAD, ALEXANDRIA, VA, 22314, US

(21) Appl. No.: 11/001,000

(22) Filed: Dec. 2, 2004

(30) Foreign Application Priority Data
Oct. 8, 2004 (JP) 2004-295715

(51) Int. Cl. G06F 12/00

(52) U.S. Cl. 711/114

(57) ABSTRACT

A disk array controller 11 decides whether a command received from a host 20-22 is a write command or a read command. If it is a write command, the disk array controller 11 generates a data block, parity block and redundancy code block from the received data, and stores the data dispersed among the plurality of disk devices D00 -D0N. If it is a read command, the disk array controller 11 uses the parity block and redundancy code block to decide whether there is an error in the read data block, and in the event there is an error in the read data block, it is corrected using the parity block and redundancy code block.

### CROSS-REFERENCE TO RELATED APPLICATION

This application relates to and claims priority from Japanese Patent Application No. 2004-295715, filed on Oct. 8, 2004, the entire disclosure of which is incorporated by reference.

### BACKGROUND

The present invention relates to a disk array device comprising a plurality of disks, and to a disk array device control method.

RAID (Redundant Array of Inexpensive Disk drives) systems are known technology for improving data access speed and reliability against disk drive malfunctions, by providing a plurality of disk devices. RAID is described in detail in “A Case for Redundant Arrays of Inexpensive Disks (RAID),” D. Patterson and 2 others, ACM SIGMOD Conference Proceeding, June 1988, p. 109-116. In a RAID system, e.g. RAID 3, in the event of a clear malfunction that returns an error in a disk or sector, data can be corrected using parity information.

A technique of appending a redundancy code to each logical data block (sector) is a known technology for ensuring that data that has been written or data that has been read is data having integrity.

### SUMMARY

However, in a RAID system, there is the problem that as long as read/write operations can be executed normally, in the event that for example, data is recorded to the wrong address or data is recorded in a corrupted state, the error cannot be detected and corrected (recovered).

With the technique of appending redundancy codes to logical data blocks (sectors), in order to write a redundancy code together with data into a given sector, it is necessary to increase the size of the sector by the equivalent of the redundancy code in addition to the normal data, which presumes that the magnetic disk has variable sector length. A resulting problem is that the technique is not applicable to fixed-sector length disks having fixed sector length, for example, the ATA disks that are widely used in disk array devices in recent years.

With the foregoing in view, there is need, in a disk array device comprising a plurality of disks of fixed sector length, to ensure that data being written and data being read have integrity.

The invention in a first aspect thereof for addressing the aforementioned problem provides a disk array device for distributed management of data in a plurality of disk devices. The disk array device pertaining to the first aspect of the invention comprises a data sending/receiving module for sending and receiving data, a plurality of disk devices having fixed sector length, wherein the plurality of disk devices stores data and redundancy information for securing contents and data store location respectively in different disk devices, and an access control module for executing data and information read/write operations to and from said disk devices.

According to the disk array device pertaining to the first aspect of the invention, data, and redundancy information are stored respectively in different disk devices, whereby the integrity of read data or write data can be ensured, even in a disk array device composed of a plurality of disk devices with fixed sector length.

The invention in a second aspect thereof provides a disk array device for distributed writing of data to N (where N is 4 or a greater natural number) of disk devices having fixed sector length. The disk array device pertaining to the second aspect of the invention comprises a data sending/receiving module for sending and receiving data; a write storage unit data generating module for generating storage unit data of predetermined distribution size using data received by said data sending/receiving module; a first error correction information generating module for generating first error correction information using write data for writing to N-2 said disk devices from among said generated storage unit data; a second error correction information generating module for generating second error correction information using storage unit data written respectively to said N-2 disk devices, and attributes of said storage unit data; and a write module for writing said storage unit data and said first and second error correction information separately to said plurality of disk devices.

According to the disk array device pertaining to the second aspect of the invention, data, error detection/correction information, and redundancy information are stored respectively in separate disk devices, whereby the integrity of read data or write data can be ensured, even in a disk array device composed of a plurality of disk devices with fixed sector length.

The invention in a third aspect thereof provides a method of controlling a disk array device for distributed management of a plurality of disk devices composed of disk devices having a plurality of storage areas of the same given size. The method of controlling a disk array device pertaining to the third aspect of the invention involves using data received from an external host computer to generate a plurality of storage unit data for distributed storage in storage areas of said disk devices; using said storage unit data which is included in a unit storage sequence formed by storage areas of disk devices making up said plurality of disk devices, to generate error detection/correction information; using said unit storage data stored in said one storage area in a said disk device and attributes of the unit storage data to generate redundancy information; and writing said generated unit storage data, error detection/correction information, and redundancy information separately to said memory area of said disk devices making up said unit storage sequence.

According to the method of controlling a disk array device pertaining to the third aspect of the invention, unit storage data, error detection/correction information, and redundancy information are stored respectively in different disk device storage areas, whereby the integrity of read data or write data can be ensured, even in a disk array device composed of a plurality of disk devices with fixed sector length.

The method of controlling a disk array device pertaining to the third aspect of the invention may also be realized in the form of a disk array device control program, and a computer-readable storage medium having a disk array device control program stored therein.

The following description of the disk array device and disk array device control method pertaining to the invention is made on the basis of exemplary embodiments, with reference to the accompanying drawings.

### BRIEF DESCRIPTION OF THE DRAWINGS

FIG. 1 is a illustration showing a simplified arrangement of the disk array device pertaining to the first embodiment.

FIG. 2 is an exterior view of the disk array device pertaining to the first embodiment.

FIG. 3 is a block diagram showing the functional arrangement of the disk array controller in the disk array device pertaining to the first embodiment.

FIG. 4 is an illustration showing modules contained in the control program.

FIG. 5 is an illustration showing an example of a RAID group management table Tb1.

FIG. 6 is an illustration showing an example of a logical unit management table Tb2.

FIG. 7 is an illustration showing an example of a setting user interface appearing on the administration screen 32 during the RAID group setting process.

FIG. 8 is an illustration showing an example of a pop-up user interface appearing on the setting user interface during the RAID group creation process.

FIG. 9 is an illustration showing an example of a setting user interface appearing on the administration screen 32 during the logical unit setting process.

FIG. 10 is an illustration showing an example of a pop-up user interface appearing on the setting user interface during the logical unit creation process.

FIG. 11 is an illustration showing the condition of storage of data blocks di, parity blocks P, and redundancy code blocks R in a plurality of disk devices making up a RAID group.

FIG. 12 is an illustration showing conceptually data blocks and a redundancy code sub-block equivalent to a parity block, contained in redundancy code block R.

FIG. 13 is an illustration showing conceptually the arrangement of the redundancy code sub-block.

FIG. 14 is a flowchart showing the processing routine executed during the data write process in the disk array device pertaining to the first embodiment.

FIG. 15 is a flowchart showing the processing routine executed during the data read process in the disk array device pertaining to the first embodiment.

FIG. 16 is a flowchart showing the processing routine executed during the redundancy code check process in the disk array device pertaining to the first embodiment.

FIG. 17 is a flowchart showing the processing routine executed during the parity check process in the disk array device pertaining to the first embodiment.

FIG. 18 is an illustration showing the condition of storage of data blocks di, parity blocks P, and redundancy code blocks R in a plurality of disk devices making up a RAID group in a Variation.

FIG. 19 is an illustration showing an example of a RAID group management table corresponding to the RAID group shown in FIG. 18.

FIG. 20 is an illustration showing conceptually the arrangement of the redundancy code in the second embodiment.

FIG. 21 is a flowchart showing the processing routine executed during the redundancy code check process in the disk array device pertaining to the second embodiment.

FIG. 22 is a flowchart showing the processing routine executed during the parity check process in the disk array device pertaining to the second embodiment.

FIG. 23 is an illustration showing the condition of storage of data blocks di, parity blocks P, and redundancy code blocks R in a plurality of disk devices making up a RAID group in the third embodiment.

FIG. 24 is a flowchart showing the processing routine executed during the data write process in the disk array device pertaining to the third embodiment.

FIG. 25 is a flowchart showing the processing routine executed during the redundancy code check process in the disk array device pertaining to the third embodiment.

FIG. 26 is a flowchart showing the processing routine executed during the data recovery process in the disk array device pertaining to the third embodiment.

FIG. 27 is a flowchart showing the processing routine executed during the parity check process in the disk array device pertaining to the third embodiment.

### DESCRIPTION OF THE PREFERRED EMBODIMENTS

### First Embodiment

Arrangement of Disk Array Device:

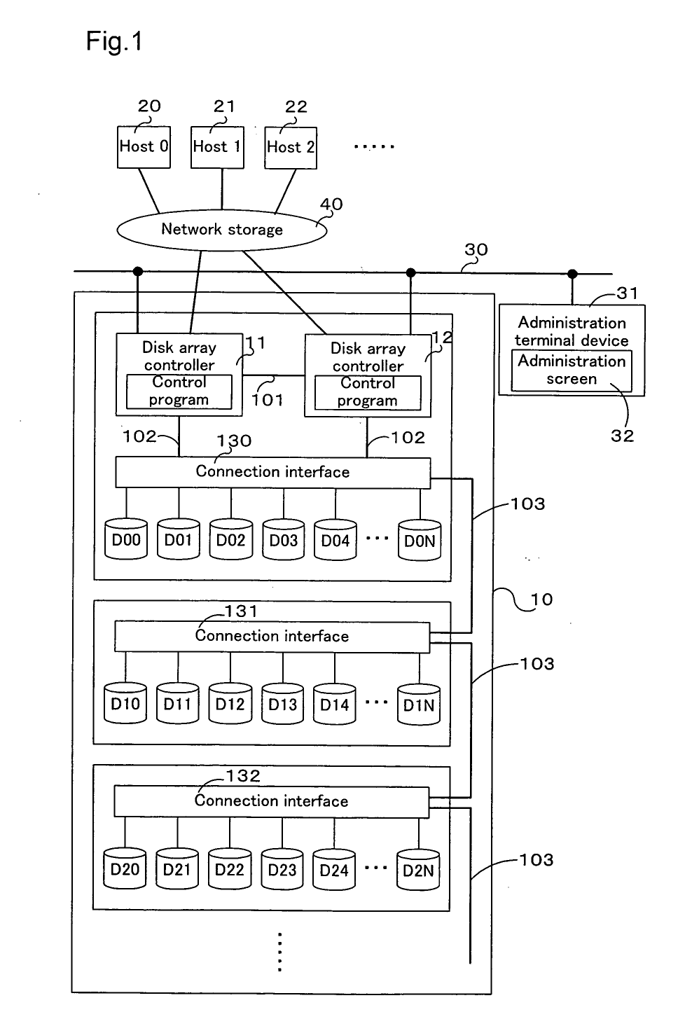

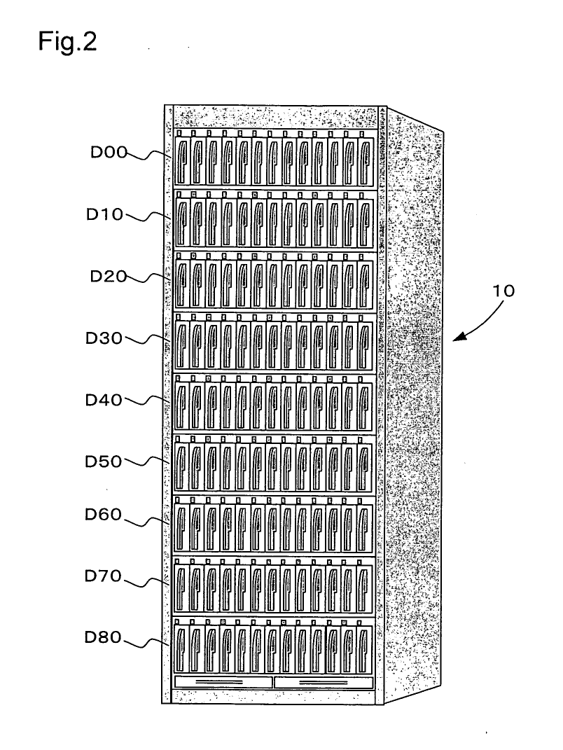

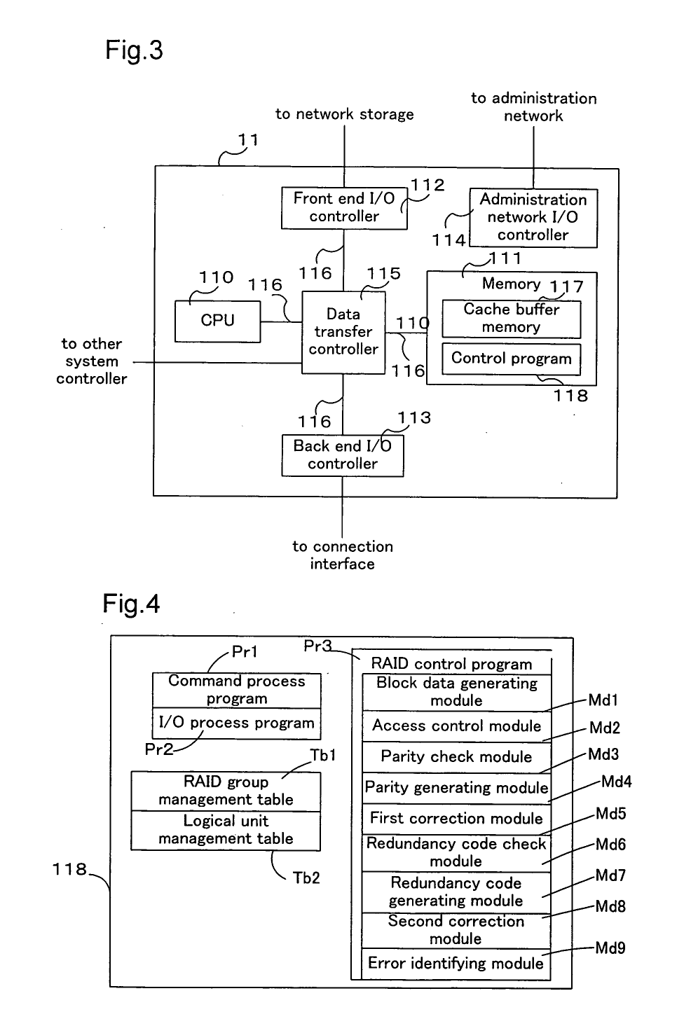

The following description of the disk array device pertaining to the first embodiment makes reference to FIGS. 1-4. FIG. 1 is a illustration showing a simplified arrangement of the disk array device pertaining to the first embodiment. FIG. 2 is an exterior view of the disk array device pertaining to the first embodiment. FIG. 3 is a block diagram showing the functional arrangement of the disk array controller in the disk array device pertaining to the first embodiment. FIG. 4 is an illustration showing modules contained in the control program.

The disk array device 10 in The first embodiment comprises disk array controllers 11, 12, connection interfaces 130, 131, 132, and a plurality of disk devices D00-D2N. The plurality of disk devices D00-D2N are disposed in disk array device 10 in the manner illustrated in FIG. 2, making up a RAID system.

The disk array controllers 11, 12 are control circuits that execute a control program in order to execute various control routines in disk array device 10. In this embodiment, two disk array controllers are provided, but instead a single, or three or more disk array controllers could be provided. The disk array controllers 11, 12 are connected via a signal line 101 to enable communication between them. The disk array controllers 11, 12 are also connected via a storage network 40 to the hosts 20, 21, 22, and connected via an administration network 30 to an administration terminal device 31. A supplemental host interface adapter could be provided in addition to the disk array controllers 11, 12. Host interface adapters include, for example, NAS (Network Attached Storage) host interface adapters and iSCSI (internet SCSI) host interface adapters. In this case, communication with the hosts 20, 21, 22 and transmission of disk access commands to the disk array controllers 11, 12 would be carried out by means of the host interface adapter.

The disk array controllers 11, 12 are connected via connection interfaces 130, 131, 132 to the plurality of disk devices D00-2N. More specifically, the connection interface 130 is connected directly to disk array controllers 11, 12 via a signal line 102, and the connection interfaces 130, 131, 132 are connected to one another via signal lines 103. Accordingly, the connection interface 131 is connected via the connection interface 130, and the connection interface 132 is connected via the connection interfaces 130, 131, to the disk array controllers 11, 12.

The connection interface 130 is connected to a plurality of disk devices D00-D0N, the connection interface 131 is connected to a plurality of disk devices D10-D1N, and the connection interface 132 is connected to a plurality of disk devices D20-D2N.

The group consisting of the plurality of disk devices D00-D0N and the connection interface 130 including the disk array controllers 11, 12 is termed, for example, the basic module; the group consisting of the plurality of disk devices D10-D1N and the connection interface 131 and the group consisting of the plurality of disk devices D20-D2N and the connection interface 132 are termed expansion modules. As will be apparent from FIG. 1, there may be a single expansion module, or none, or three or more. In this embodiment, the disk array controllers are disposed in the same module as disk devices D00-D2N, but could instead constitute a separate module, connected via appropriate signal lines.

The hosts 20, 21, 22 are, for example, terminal devices for inputting data of various kinds; data processed in the hosts 20, 21, 22 is sent in serial fashion to the disk array device 10, and is stored in the disk array device 10. The hosts 20, 21, 22 may instead be one or four or more in number.

Each of the disk devices D00-D2N is a hard disk drive of fixed sector length, for example, a hard disk drive of ATA specification.

The administration terminal device 31 is a terminal device used for executing maintenance administration of the disk array device 10, and is different from the hosts 20-22. The administration terminal device 31 is provided with an administration screen 32; through the administration screen 32, a use can administer the status of the disk array device 10.

The following description of the internal arrangement of the disk array controller 11 makes reference to FIG. 3. The disk array controller 11 comprises a CPU 110, memory 111, a front end I/O controller 112, a back end I/O controller 113, an administration network I/O controller 114, and a data transfer controller 115.

The CPU 110, the memory 111, the front end I/O controller 112, the back end I/O controller 113, and the administration network I/O controller 114 are interconnected via the data transfer controller 115, by means of signal lines 116.

In the memory 111 there is provided cache buffer memory 117 for temporarily storing data read from a disk device D, data being written to a disk device, and results of operations by the CPU 110; a control program 118 executed by the CPU 110 is stored there as well. A detailed description of the control program 118 will be made later, with reference to FIG. 4.

The front end I/O controller 112 is connected to the storage network 40, and exchanges data and commands with hosts 20-22. The back end I/O controller 113 is connected to the connection interface 130 (131, 132) and executes exchange of data with disk devices D. The data transfer controller 115 executes control of data transfer among the CPU 110, the memory 111, and the front and the back end I/O controllers 112, 113. The data transfer controller 115 also controls transfer to data with respect to other disk array controllers.

The administration network I/O controller 114 is connected to the administration network 20, and executes exchange of commands with the administration terminal device 31.

The description now turns to the details of the control program 118, with reference to FIG. 4. The control program 118 comprises a command process program Pr1, an I/O process program Pr2, a RAID control program Pr3, a RAID group management table Tb1, and a logical unit management table Tb2.

The command process program Pr1 is a program that interprets commands received from the hosts 20-22, and transfers commands to a command execution module; for example, it decides whether a command to be executed is a data write command or a read command.

The I/O process program Pr2 is a program for controlling exchange of data and commands with the hosts 20, 22, other disk array controllers, and the connection interface 130.

The RAID control program Pr3 is a program for executing various types of principal controls in this embodiment, and executes various processes for executing RAID. The RAID control program Pr3 comprises a data block generating module Md1, an access control module Md2, a parity check module Md3, a parity generating module Md4, a first correction module Md5, a redundancy code check module Md6, a redundancy code generating module Md7, a second correction module Md8, and an error identifying module Md9.

The data block generating module Md1 is a module for dividing data targeted for writing, into data blocks appropriate for sector size, which is the storage unit of disk devices D. The access control module Md2 is a module for executing writing of data blocks to the disk devices D, and reading of data blocks stored in the disk drives D, corresponding to the requested data.

The parity check module (second decision module) Md3 is a module for determining whether parity data (error detection/correction information) stored in a disk device D is correct. The parity generating module (first error detection/correction information generating module) Md4 is a module for generating parity data (parity blocks) for storage in disk devices D. The first correction module Md5 is a module used to correct (recover) parity blocks or data blocks.

The redundancy code check module (first decision module) Md6 is a module for determining whether redundancy code (redundancy information) blocks (redundancy code blocks) stored in the disk devices D are correct. The redundancy code generating module (second error detection/correction information generating module) Md7 is a module for generating redundancy code (redundancy code blocks) for storage in the disk devices D. The error identifying module Md9 is a module used to identify whether an error has occurred in a parity block or occurred in a data block, or whether an error has occurred in a redundancy code block or occurred in a data block.

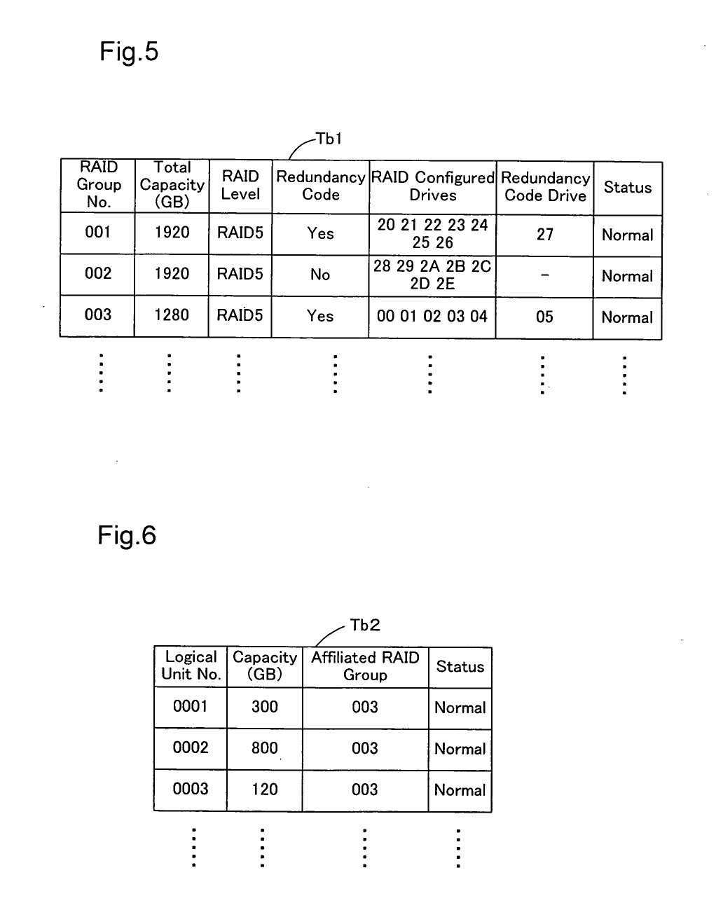

The RAID group management table Tb1 is a table used for managing information of various kinds for the disk devices making up RAID groups, and holds the information shown in FIG. 5, for example. Here, FIG. 5 is an illustration showing an example of a RAID group management table Tb1.

The RAID group management table Tb1 shown in FIG. 5 holds information regarding the RAID group No., the RAID group total storage capacity, the RAID level, redundancy code Yes/No, the disk devices making up RAID groups, and status. In the example shown in FIG. 5, for example, RAID group 001 has total capacity of 1920 GB, the RAID level is RAID 5, redundancy code is Yes, the constituent disks are 20-26, the disk device storing the redundancy code block is 27, and status is normal.

The logical unit management table Tb2 is a table for managing logical units, and holds the information shown in FIG. 6, for example. Here, FIG. 6 is an illustration showing an example of the logical unit management table Tb2.

The logical unit management table Tb2 shown in FIG. 5 holds information regarding the logical unit capacity, the RAID group No. to which it belongs, and status. In the example shown in FIG. 6, for example, the logical unit 002 has capacity of 800 GB, belongs to the RAID group 003, and is functioning normally. As will be apparent to the practitioner of the art, a logical unit means a logical memory area provided by one or several physical disk devices D, able to be handled beyond the physical memory capacity of the individual disk devices D.

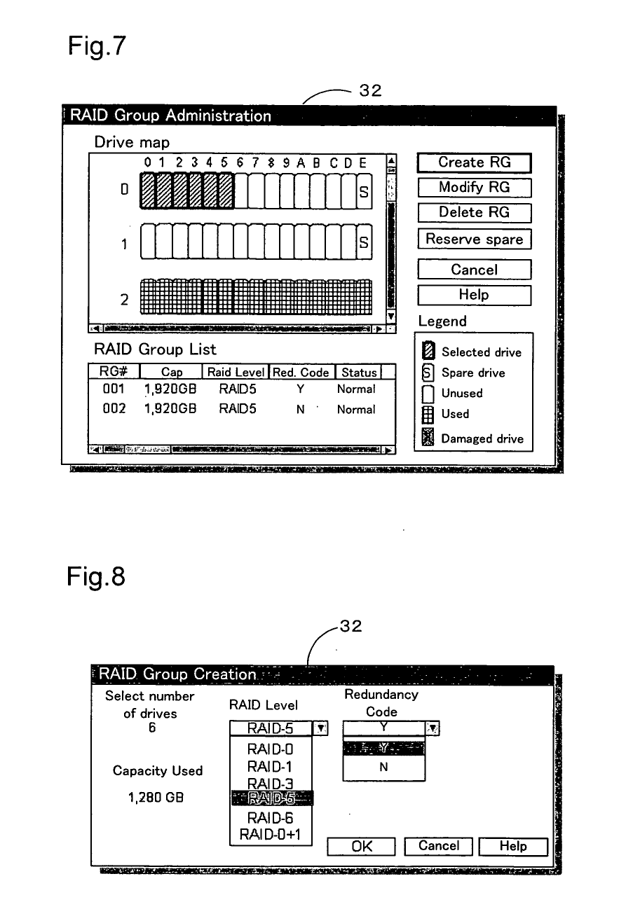

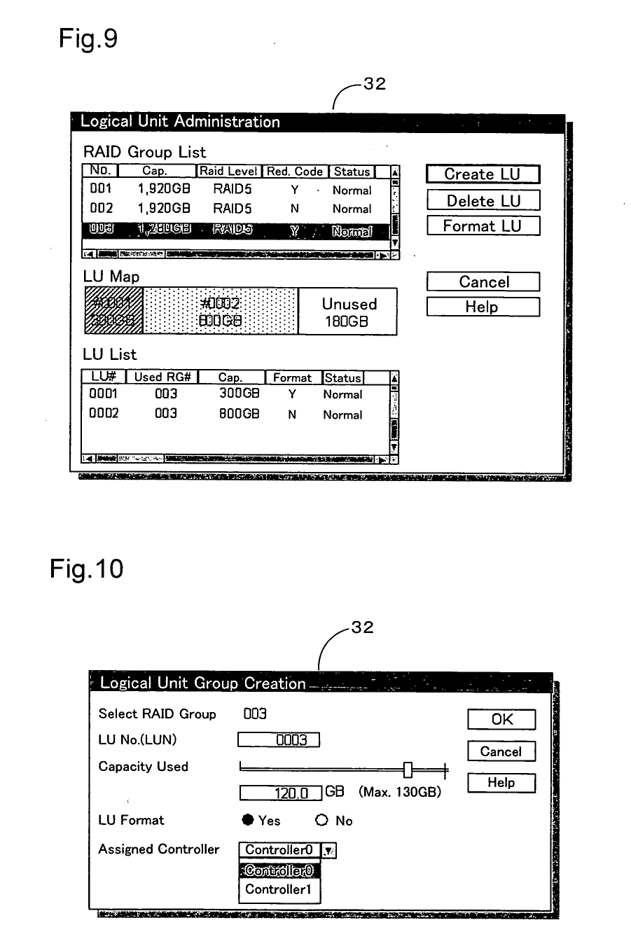

The following description of the RAID group setting process and logical unit setting process, executed through administration terminal device 31, makes reference to FIGS. 7-10. FIG. 7 is an illustration showing an example of a setting user interface appearing on the administration screen 32 during the RAID group setting process. FIG. 8 is an illustration showing an example of a pop-up user interface appearing on the setting user interface during the RAID group creation process. FIG. 9 is an illustration showing an example of a setting user interface appearing on the administration screen 32 during the logical unit setting process. FIG. 10 is an illustration showing an example of a pop-up user interface appearing on the setting user interface during the logical unit creation process.

As shown in FIG. 7, on the administration screen 32 are displayed a drive map indicating disk device (drive) status, a RAID group list showing the RAID group management table Tb1, and a RAID group administration window that includes various setting buttons. In the RAID group administration window it is possible to confirm, through the RAID group list, the RAID level of the RAID group, and redundancy code Yes/No. When creating a RAID group, disk devices D for making up the RAID group are selected. For example, in the example of FIG, 7, disk devices D00-D05 are selected on the drive map, in order to create a RAID group, and when in this state the “Create RG” button is pressed, the RAID group creation window shown in FIG. 8 pops up. In the RAID group creation window shown in FIG. 8, selection of a level for the RAID being created, and of whether to append a redundancy code are made. In the example of FIG. 8, the RAID level is set to RAID 5, and redundancy code is set to Yes.

Next, for the RAID group created in this way, creation of a logical unit is executed. As shown in FIG. 9, there are displayed on the administration screen 32 an LU map indicating status of the logical unit in the RAID group, a RAID group list showing RAID group management table Tb1, an LU list showing logical unit management table Tb2, and a logical unit administration window that includes various setting buttons. In the logical unit administration window it is possible to confirm, through the RAID group list, the RAID level of the RAID group, and redundancy code Yes/No; and through the LU list, to perform confirmation of logical unit settings. In the example shown in FIG. 9, RAID group 003 has formed therein a logical unit 0001 previously assigned useable capacity of 300 GB, and a logical unit 0002 assigned useable capacity of 800 GB.

In creating a logical unit (LU), a RAID group for creating the logical unit is selected. For example, in the example of FIG. 9, the RAID group 003 is selected from the RAID group list, and when in this state the “Create LU” button is pressed, the logical unit creation window shown in FIG. 10 pops up. In the logical unit creation window shown in FIG. 10, selection is made of the logical unit number (LUN) being created and its useable capacity, logical unit formatting Yes/No, and setting/selection of a disk array controller for controlling the created logical unit. In the example of FIG. 10, the LUN is 003, useable capacity is 120 GB, LU formatting is Yes, and the controlling disk array controller is set to 0.

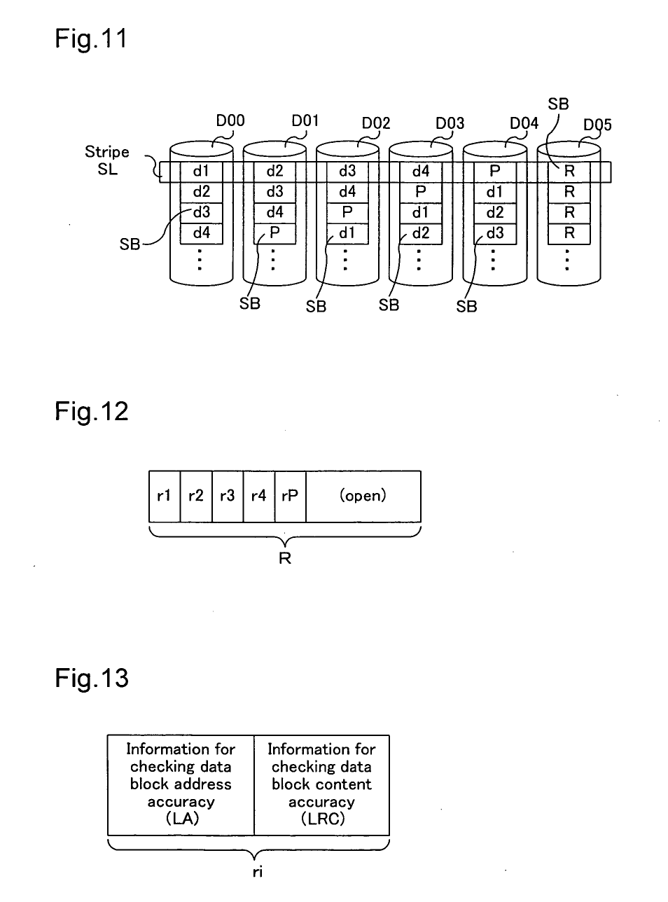

The following specific description of data blocks di, parity blocks P, and redundancy code blocks R in a plurality of disk devices D00-D05 making up a RAID group makes reference to FIGS. 11-13. FIG. 11 is an illustration showing the condition of storage of data blocks di, parity blocks P, and redundancy code blocks R in a plurality of disk devices making up a RAID group. FIG. 12 is an illustration showing conceptually data blocks and a redundancy code sub-block equivalent to a parity block, contained in redundancy code block R. FIG. 13 is an illustration showing conceptually the arrangement of the redundancy code sub-block.

As shown in FIG. 11, each of the disk devices D00-D05 contains a plurality of storage areas SB (blocks/sectors) of identical capacity; the group of storage areas SB of the disk devices D00-D05 making up a RAID group in turn make up a unit storage sequence SL (stripe) spanning all of the disk devices D00-D05. The storage areas SB of the disk devices D00-D05 making up stripe SL have stored respectively therein data blocks d1, d2, d3, d4, parity blocks P, and redundancy code blocks R. The RAID group shown in FIG. 11 has a RAID level of RAID 5, with a parity block P distributed to each disk device D00-05. The redundancy code blocks, on the other hand, are consolidated in one disk device D05, different from the disk devices D00-D04 in which the data blocks di are stored.

As shown in FIG. 12, a redundancy code block R contains redundancy code sub-blocks r1-r4 corresponding to the data blocks d1-d4 stored in storage areas SB, and a redundancy code sub-block rP corresponding to the parity block P. The unused area is initialized during LU formatting, and thus does not indicate an indeterminate value, for example, indicating a value of 0.

As shown in FIG. 13, the redundancy code sub-blocks r1-r4 and rP contain addresses at which data blocks are stored, i.e., location check information that verifies the correctness of addresses for accessing data blocks stored in disk devices D, for example, information that verifies the correctness of the logical address (LA), logical block address (LBA), and data block contents (data check information), for example, lateral parity data (LRC) or vertical parity data (VRC). A logical address is an address that indicates a storage (access) location on a logical unit; a logical block address is an address that indicates an access location on a logical block (sector). Lateral parity data and vertical parity data are information derived by calculation methods known in the art, and used for error detection and correction; where one sector consists of 512 bytes, for example, these would be calculated by accumulating data blocks every 4 bytes in 128 stages in the vertical direction, and calculating exclusive OR on a column-by-column or row-by-row basis.

The parity blocks P can be derived by calculating exclusive OR of the data blocks d1-d4 contained in each stripe.

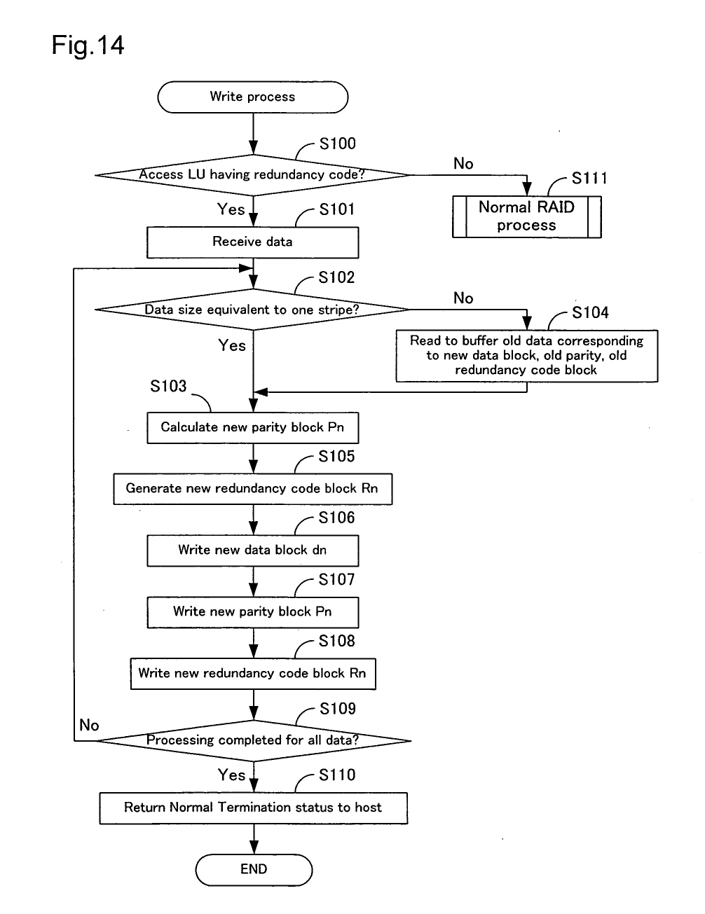

The data write (update) process in the disk array device 10 pertaining to the first embodiment is now described with reference to FIG. 14. FIG. 14 is a flowchart showing the processing routine executed during the data write process in the disk array device pertaining to the first embodiment.

The flowchart shown in FIG. 14 is executed in the event that a command received from a host 20-22 is interpreted (decided) to be a write command, by means of the command process program Pr1 executed by THE CPU 110.

When the CPU 110 receives a command from a host 20-22, it executes the command process program Pr1 and decides whether the received command is a command requesting access to a logical unit (LU) having a redundancy code (Step S100), and in the event of a decision that access to a logical unit (LU) having a redundancy code is being requested (Step S100: Yes), secures a cache buffer memory 117 in the memory 111, and receives data from the host 20-22 (Step S101).

The CPU 110 decides whether the received data or remaining data is equivalent to one stripe SL (Step S102). Specifically, it decides whether the size of the data remaining in the cache buffer memory 117 is equal to or greater than the size of one stripe SL.

In the event that the CPU 110 decides that data in the cache buffer memory 117 is equivalent to one stripe SL (Step S102: Yes), it uses data blocks created from the received data, to calculate a new parity block (Step S105). Specifically, data blocks in a number corresponding to one stripe SL are acquired from the created blocks, and a parity block P is calculated using the data blocks so acquired. In this embodiment, since four data blocks are stored in one stripe SL, parity block P is calculated using four data blocks d1-d4.

In the event that the CPU 110 decides that the data in the cache buffer memory 117 is less than the equivalent of one stripe SL (Step S102: No), it reads into the cache buffer memory 117 old data (data blocks) corresponding to the new data (data block), the old parity block Po, and the old redundancy code block Ro (Step S104). A case in which the size of the received data is less than the equivalent of one stripe SL, or a case in which after multiple write operation a data block which is less than the equivalent of one stripe SL remains would fall into this category. The CPU 110 uses the old data block do, the old parity block Po, and the old redundancy code block Ro read into the cache buffer memory 117 to calculate a new parity block Pn (Step S103).

In the event that the CPU 110 decides that a data size of the new data block dn (equivalent to one stripe SL or a predetermined number) and the new parity block Pn is less than the equivalent of one stripe SL, the old redundancy code block Ro is used in addition, to create a new redundancy code block Rn (Step S105). Specifically, the CPU 110 reads out the offset value for the lead position of the logical address (LA) from the storage location information appended to the data, calculates a logical address (LA), and calculates a new data block dn, and lateral parity (LRC) of new parity block Pn.

The CPU 110 writes the new data block dn to the calculated logical address (LA) (Step S106), writes the new parity block Pn (Step S107), and writes the new redundancy code block Rn to the redundancy code disk device D05 (Step S108).

The CPU 110 then determines whether the write process has been completed for all data in the cache buffer memory 117 (Step S109), and in the event it determines that there is remaining data in the cache buffer memory 117 (Step S109: No), repeats executing of Step S102-Step S108. If the CPU 110 determines that the write process has been completed for all data in the cache buffer memory 117 (Step S109: Yes), it releases the cache buffer memory 117, and returns to the host 20-22 status to the effect that the command has terminated normally (Step S110), whereupon the processing routine terminates.

In Step S100, in the event of a decision that access is not requested to a logical unit having a redundancy code (Step S100: No), the normal RAID process is executed (Step S111). In the RAID process, received data is subjected to striping (division) across data blocks d, a parity block P is calculated from the data blocks d, and write process to the corresponding disk device is executed. Since the RAID process is known art, it need not be described in detail herein.

In the case of initially writing data to a disk device D as well, a write process similar to the process described above is executed. For example, a “0” is written to each disk device D by means of a formatting process (initialization), and a “1” (even parity) or a “0” (odd parity) is written to the parity block P.

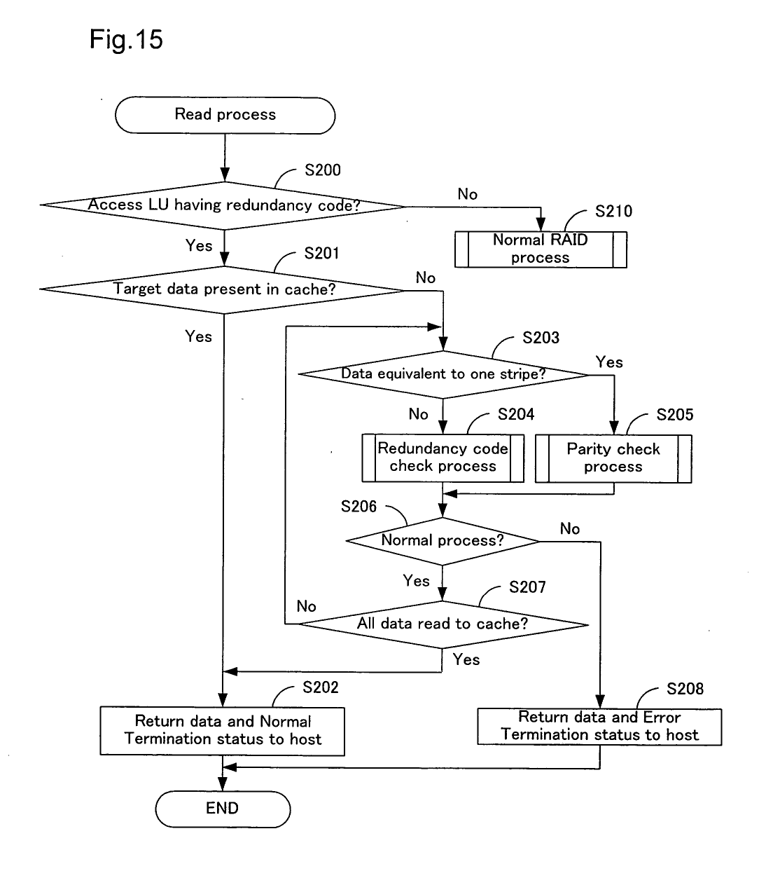

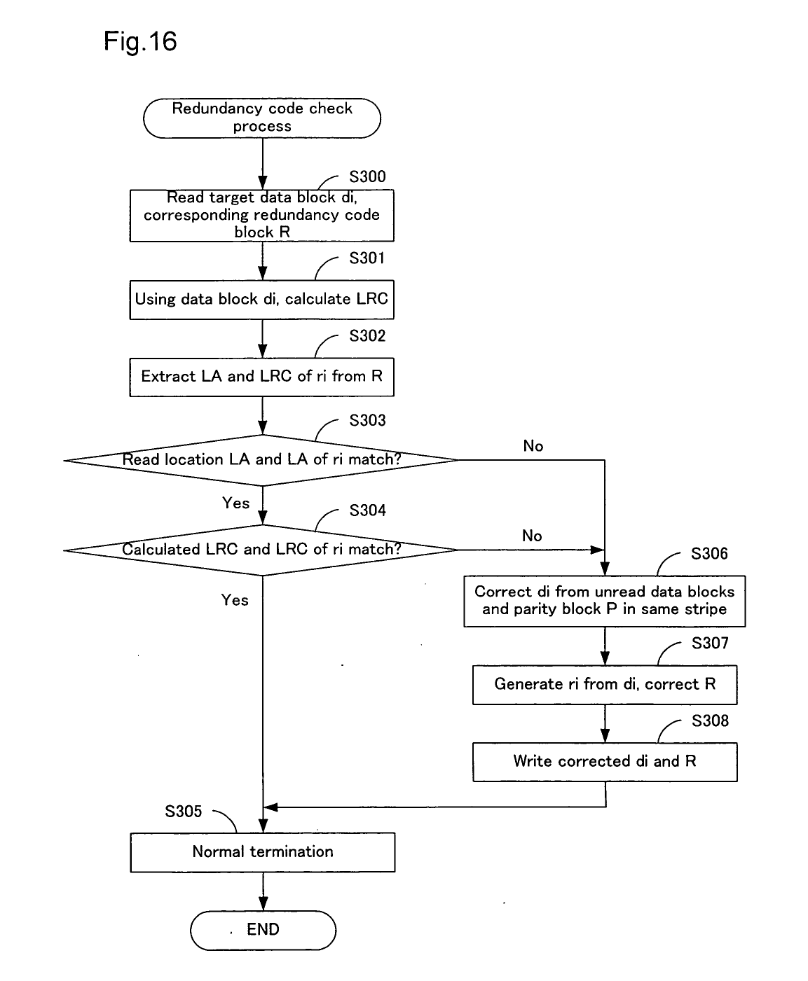

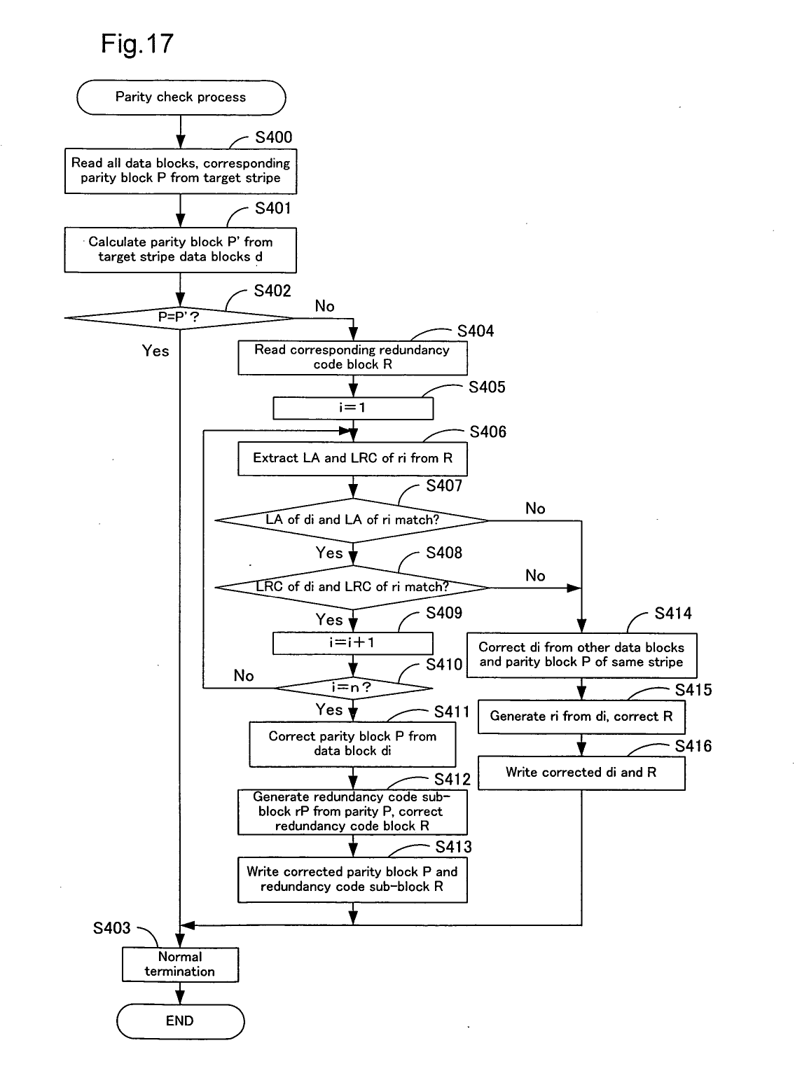

The data read process in the disk array device 10 pertaining to the first embodiment is now described with reference to FIGS. 15-17. FIG. 15 is a flowchart showing the processing routine executed during the data read process in the disk array device pertaining to the first embodiment. FIG. 16 is a flowchart showing the processing routine executed during the redundancy code check process in the disk array device pertaining to the first embodiment. FIG. 17 is a flowchart showing the processing routine executed during the parity check process in the disk array device pertaining to the first embodiment.

The flowchart shown in FIG. 15 is executed by the command process program Pr1 executed by the CPU 110, in the event that a command received from a host 20-22 is interpreted (decided) to be a read command.

When the CPU 110 receives a command from a host 20-22, it executes the command process program Pr1 and decides whether the received command is a command requesting access to a logical unit (LU) having a redundancy code (Step S200); and in the event of a decision that access to a logical unit (LU) having a redundancy code is being requested (Step S200: Yes), decides whether a data block di corresponding to the requested data exists in the cache buffer memory 117 (Step S201). That is, it is determined whether or not there is a cache hit. For example, in the event that identical data has been read in a previous process and the data is remaining in the cache buffer memory 117, the requested data can be read out faster than if a disk device D were accessed. Since the CPU 110 has information of the storage logical address of data (data block di) read into the cache buffer memory 117, it can decide whether the requested data is present in the cache buffer memory 117.

In the event that the CPU 110 decides that the data block di corresponding to the requested data is present in the cache buffer memory 117 (Step S201: Yes), it forms data from the read data block, and returns to the host 20-22 the requested data together with normal termination status (Step S202), whereupon the processing routine terminates.

In the event that the CPU 110 decides that the data block di corresponding to the requested data is not present in the cache buffer memory 117 (Step S201: No), it decides whether the data requested to be read is data equivalent to one stripe SL (Step S203). Specifically, it decides whether the size of the data requested to be read is equal to or greater than the size of one stripe SL.

In the event that the CPU 110 decides that data requested to be read is not data equivalent to one stripe SL (Step S203: No), it executes a redundancy code check process (Step S204). If on the other hand the CPU 110 decides that data requested to be read is data equivalent to one stripe SL (Step S203: Yes), it executes a parity check process (Step S205). The redundancy code check process and parity check process will be described in detail making reference to FIG. 16 and FIG. 17.

Once the redundancy code check process or parity check process has terminated, the CPU 110 decides whether the read process terminated normally (Step S206), and if determined to have terminated normally (Step S206: Yes), it is decided whether the requested data (all of the data blocks) have been read into the cache buffer memory 117 (Step S207). In the event that the CPU 110 decides that all requested data has been read into cache buffer memory 117 (Step S207: Yes), it moves on to Step S202, and the processing routine terminates.

In the event that the CPU 110 decides that not all of the requested data has been read into the cache buffer memory 117 (Step S207: No), execution of the process of Step S203 -Step S206 is repeated.

In Step S206, in the event that the CPU 110 decides that the read process has not terminated normally (Step S206: No), it returns error termination status to the host 20-22 (Step S208) and terminates the processing routine.

In Step S200, in the event that the CPU 110 decides that access to a logical unit (LU) having a redundancy code has not been requested (Step S200:No), the normal RAID process is executed (Step S210). In the normal RAID process, the read data blocks di and parity blocks P are used to determine if there is error in the read data blocks, and once all of the data blocks di corresponding to the requested data in the cache buffer memory 117 have been read, the requested data is returned to the host.

The following description of the redundancy code check process makes reference to FIG. 16. The CPU 110 reads the target data block di targeted to be read, and the corresponding redundancy code block R from disk device D (Step S300). At this time, the CPU 110 calculates the logical address (LA) using the offset value indicating the storage location of the data that the host has requested be read out, and identifies the storage location of the target data block di. The CPU 110 holds the logical address (LA) derived by means of this calculation.

The CPU 110, using the read data block di, calculates the lateral parity LRC (Step S301), and extracts the LRC and the LA of the ri from the corresponding redundancy code block R (Step S302). The CPU 110 then decides whether the read location LA calculated by means of conversion matches the LA of the ri(Step S303), and in the event it determines that these match (Step S303: Yes), then decides whether the LRC calculated from the read data block di matches the LRC of the ri(Step S304). In the event that the CPU 110 decides that the LRC calculated from the read data block di matches the LRC of the ri(Step S304: Yes), it decides that the read data block di is correct, and terminates the processing routine, leaving behind normal termination status (Step S305).

In the event that the CPU 110 decides that the read location LA derived by calculation does not match the LA of the ri(Step S303: No) or decides that the LRC calculated from the read data block di does not match the LRC of the ri(Step S304: No), it corrects (recovers) data block di from the parity block and unread data blocks of the same stripe SL that contains the read data block di (Step S306). Specifically, this is executed by taking the exclusive OR of the unread data blocks and parity block.

The CPU 110 generates the ri from the corrected data block di, corrects the redundancy code block R (Step S307), writes the corrected data block di and the redundancy code block R to the corresponding address of the corresponding disk (Step S308), and terminates the processing routine, leaving behind normal termination status (Step S305). The reason for correcting both the data block di and the redundancy code block R is that if either the data block di or the redundancy code block R is in error, the LA or LRC of the two in Steps 303, 304 will not match as a result.

The following description of the parity check process makes reference to FIG. 17. The CPU 110 reads all of the data blocks di (d1-d4) and the corresponding parity block P of the targeted stripe SL (Step S400), and using the read blocks d1-d4 calculates a parity block P′ (Step S401). At this time, the CPU 110 calculates the logical address (LA) using the offset value indicating the storage location of the data that the host has requested be read out, and identifies the storage locations of the target data blocks di. For all of the data blocks di read out, the CPU 110 holds the logical address (LA) calculated at the time they were read. The CPU then decides whether the read parity block P and the calculated parity block P′ are equal (Step S402), and if it determines that P=P′ (Step S402: Yes), it deems the read data blocks d1-d4 are to be correct, and terminates the processing routine, leaving behind normal termination status (Step S403).

In the event that the CPU 110 decides that the read parity block P and the calculated parity block P′ are not equal (Step S402: No), it reads the corresponding redundancy code block R (Step S404) and designates that i=1 (Step S405). In the event that that the read parity block P and the calculated parity block P′ are not equal, either the parity block P or data block di must be in error, so the redundancy code R is used to determine whether data block di is correct. “i” is the number of a data block di contained in one stripe SL; in this embodiment, it can assume integral values of 1 to 4.

The CPU 110 extracts from the redundancy code block R the LA and LRC stored in the ri(Step S406), and decides whether the LA of data block di and the LA of the ri match (Step S407). If the CPU 110 decides that the LA of data block di and the LA of the ri match (Step S407: Yes), it then decides whether the LRC of data block di and the LRC of the ri match (Step S408.)

If the CPU 110 decides that the LRC of data block di and the LRC of the ri match (Step S408: Yes), it increments i by 1 (i=i+1) (Step S409) and decides whether i=n (Step S410). That is, it is determined whether a check has been completed for all of the data blocks di. In this embodiment, since i goes up to 4, n is defined as 5, which is equal to i+1.

If the CPU 110 decides that i=n, that is, that checks have been completed for all of the data blocks di (Step S410: Yes), the parity block P is corrected using checked data block di (d1-d4) (Step S411). In the event that the LA and LRC of data blocks di match the LA and LRC of ri, data blocks di are all deemed normal. Accordingly, the parity block P is corrected using the normal data blocks di.

The CPU 110 uses the corrected parity block P to generate rP, and corrects the redundancy code block R (Step S412). Specifically, using the parity block P, the LA and LRC are calculated, and any redundancy code block R possible generated by an erroneous parity block P is corrected using the rP generated by a normal parity block P.

The CPU 110 writes the corrected parity block P and redundancy code block R to predetermined storage locations in the disk D in accordance with the LA (Step S413), and terminates the processing routine, leaving behind normal termination status (Step S403).

If the CPU 110 decides that the held LA does not match the LA of the ri (Step S407: No), or decides that the LRC calculated from the read data block di does not match the LRC of the ri (Step S408: No), it corrects the di from the parity block and the unread data blocks of the same stripe SL that contains the read data block di (Step S306). Specifically, this is executed by taking the exclusive OR of the unread data blocks and the parity block. In the event that the held LA does not match the LA of ri, or that the LRC calculated from the read data block di does not match the LRC of ri, this means that the read data block di is erroneous, so the data block di is corrected using the parity block P and the other data blocks belonging to the same stripe SL.

The CPU 110 generates the ri from the corrected di and corrects the redundancy code block R (Step S415), writes the data block di and redundancy code block R to predetermined storage locations in the disk D in accordance with the LA (Step S413), and terminates the processing routine, leaving behind normal termination status (Step S403).

As described above, according to the disk array device 10 pertaining to the first embodiment of the invention, each strip SL includes, in addition to the data blocks di and the parity block P, a redundancy code block R for verifying data block di storage locations (LA) and the integrity of data blocks di, whereby error can be detected in the event that a data block is recorded to an incorrect address, or in the event that or a data block is recorded in a corrupted state. That is, the problem that as long as read/write operations can be executed normally, error in a data block di cannot be detected and corrected, is solved thereby.

Additionally, since redundancy code blocks R are stored in a disk device D different from the disk device D storing data blocks di, the arrangement is applicable to a disk array device 10 composed of fixed sector length disk devices of fixed sector length.

Further, by using the redundancy code blocks R, the occurrence of error in eight a data block di or parity block P can be identified, and the error which has occurred corrected. Accordingly, the reliability of the disk array device 10 can be improved, and data integrity can be assured.

Variation:

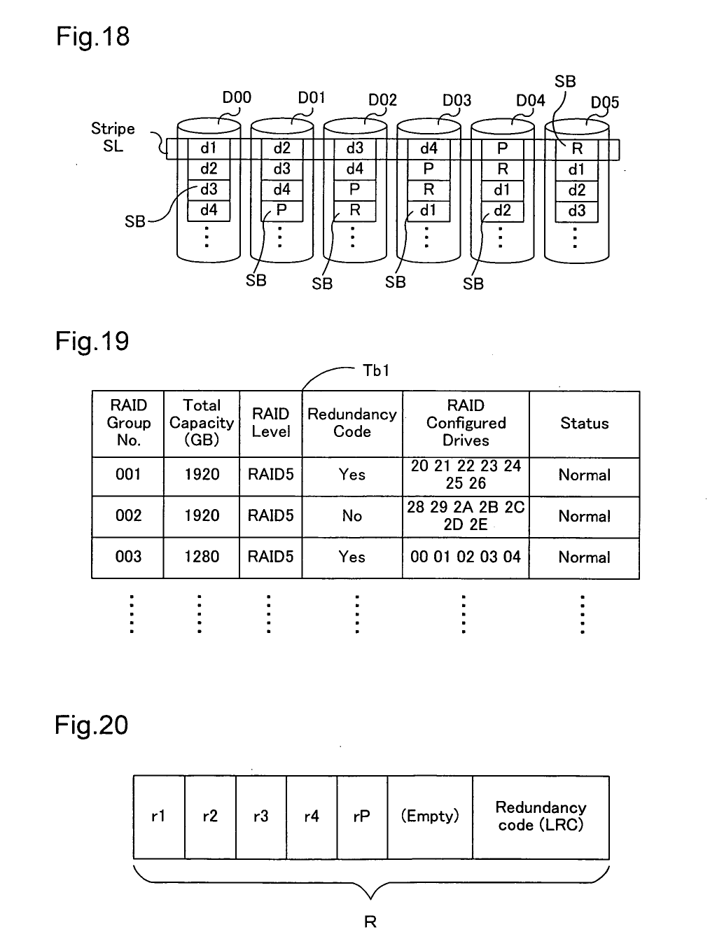

The following description of a variation of the disk array device 10 pertaining to the first embodiment makes reference to FIG. 18 and FIG. 19. FIG. 18 is an illustration showing the condition of storage of data blocks di, parity blocks P, and redundancy code blocks R in a plurality of disk devices making up a RAID group in the Variation. FIG. 19 is an illustration showing an example of a RAID group management table corresponding to the RAID group shown in FIG. 18.

In the first embodiment above, redundancy code blocks R are stored in a dedicated disk device D for storing redundancy code blocks R, but like parity blocks P, could instead be stored dispersed through a plurality of disk devices D. In this case, the redundancy code drive item would disappear from the RAID group management table.

As shown in this Variation, by storing redundancy code blocks R dispersed through a plurality of disk devices D, higher speeds can be obtained by means of parallel access. That is, where the redundancy code blocks R are stored on a specific disk device D, in the event that access to data blocks di belonging to different stripes SL is executed, while it will be possible to access the data blocks di in parallel, it will be necessary to wait in turn to access a redundancy code block R stored on a given disk device D, thereby creating a bottleneck. In contrast, where the redundancy code blocks R are stored dispersed through a plurality of disk devices D as in this Variation, parallel access in a manner analogous to access of data blocks di is possible.

### Second Embodiment

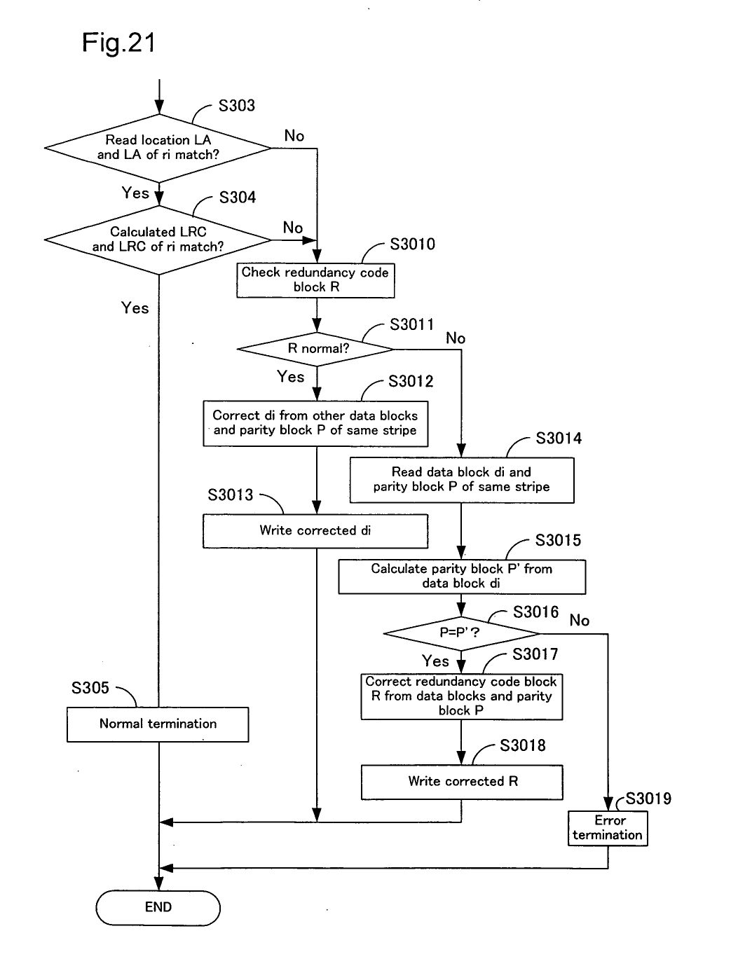

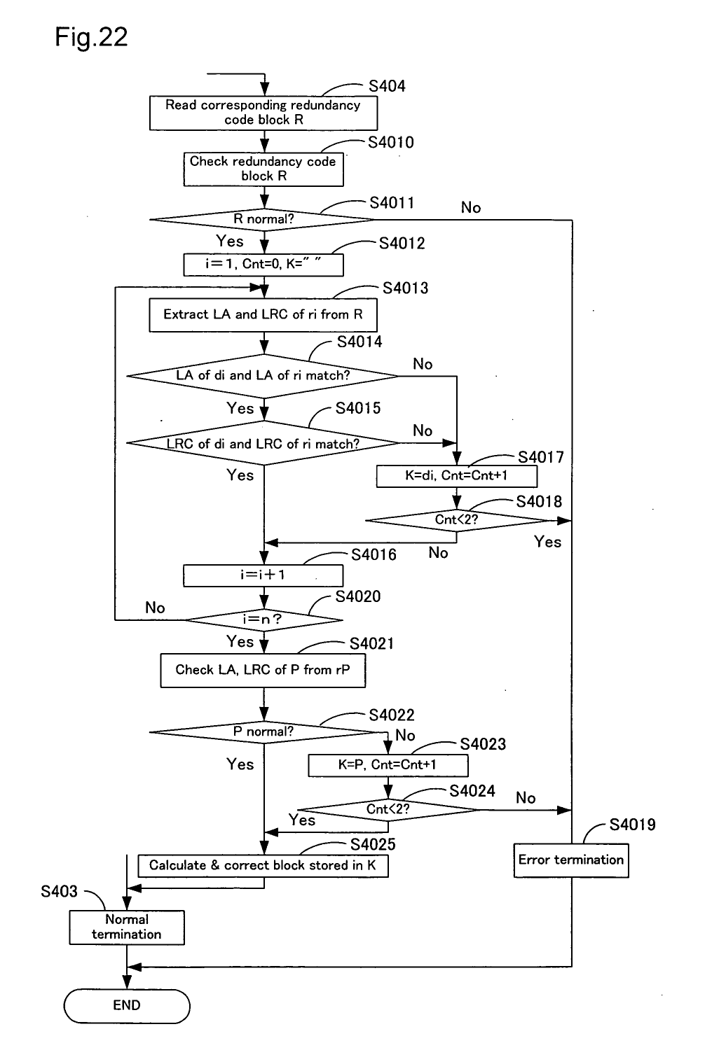

The following description of the disk array device control method pertaining to the second embodiment of the invention makes reference to FIGS. 20-22. FIG. 20 is an illustration showing conceptually the arrangement of the redundancy code in the second embodiment. FIG. 21 is a flowchart showing the processing routine executed during the redundancy code check process in the disk array device pertaining to the second embodiment. FIG. 22 is a flowchart showing the processing routine executed during the parity check process in the disk array device pertaining to the second embodiment. Steps described previously in the first embodiment using FIG. 16 and FIG. 17 are partially omitted in the drawings.

As shown in FIG. 20, the disk array device of the second embodiment differs from the disk array device 10 of the first embodiment in that it has a redundancy code check code (second data redundancy information, e.g. LRC) for the redundancy code sub-blocks ri and rP making up a redundancy code block R. In other respects the arrangement of the disk array device is the same, and thus identical symbols are assigned here without any further description of disk array device arrangement.

The redundancy code check process of the second embodiment is now described with reference to FIG. 21. In Step S300 up through Step S305, a process analogous to the redundancy code check process in the first embodiment is carried out, and thus it need not be described here.

In the event that the CPU 110 decides that the read location LA derived by calculation does not match the LA of the ri (Step S303: No) or decides that the LRC calculated from the read data block di does not match the LRC of the ri (Step S304: No), it checks the redundancy code of the redundancy code block R (Step S3010). That is, since an abnormality (error) has occurred in either the data block di or the redundancy code block R, a process to correct the error is carried out. Specifically, it is determined whether the redundancy code check code (LRC) calculated using the redundancy code sub-blocks ri (r1-r4) and rP matches the redundancy code check code (LRC) stored in the redundancy code block R.

In the event that the CPU 110 determines that the redundancy code block R is normal, i.e. that the redundancy code check code (LRC) calculated using the redundancy code sub-blocks ri (r1-r4) and rP matches the redundancy code check code (LRC) stored in the redundancy code block R (Step S3011: Yes), it corrects di from the parity block P and the other data blocks in the same stripe SL that includes the read data block di (Step S3012). Specifically, this is executed by means of exclusive OR of the other data blocks and parity block P.

The CPU 110 writes the corrected data block di to the corresponding address of the corresponding disk (Step S3013), and terminates the processing routine, leaving behind normal termination status (Step S305).

In the event that the CPU 110 determines that the redundancy code block R is not normal (Step S3011: No), it reads the parity block P and the other data blocks of the same stripe SL (Step S3014), and calculates a parity block P′ using data blocks d1-d4 (Step S3015). The CPU 110 then decides whether the read parity block P and the calculated parity block P′ are equal (Step S3016), and if it determines that P=P′ (Step S3016: Yes), it corrects the redundancy code block R from the data block di and parity block P (Step S3017). That is, this corresponds to a case where the read data block di is normal, and an error has occurred in the redundancy code block R. The fact that the data block di is normal may be verified by comparing the parity blocks P and P′. Correction of the redundancy code block R is carried out, specifically, by using the data blocks di and parity block P to recalculate redundancy code sub-blocks ri, rP, and then recalculating the redundancy code check code (LRC) of the redundancy code block R by means of the ri and rP. The CPU 110 writes the corrected redundancy code block R to the corresponding address of the corresponding disk (Step S3018), and terminates the processing routine, leaving behind normal termination status (Step S305). If on other hand P and P′ are not equal (Step S3016: No), since the CPU 110 cannot identify the location of the error, i.e. whether the error is in the redundancy code block R, whether the error is in the data block di requested from the host, or whether while the data block di is correct, another data block has been read in error from the same stripe SL, it terminates the processing routine, leaving behind error termination status (Step S3019).

The following description of the parity check process in the second embodiment makes reference to FIG. 22. In Step S400 up through Step S404, a process analogous to the parity check process in the first embodiment is carried out, and thus it need not be described here.

The CPU 110 reads the corresponding redundancy code block R (Step S404), and checks the redundancy code of the redundancy code block R (Step S4010). In the event that the CPU 110 decides that the redundancy code block R is normal, i.e. that the redundancy code check code (LRC) calculated using the redundancy code sub-blocks ri (r1-r4) and rP matches the redundancy code check code (LRC) stored in the redundancy code block R (Step S4011: Yes), it makes the settings i=1, counter Cnt=0, and variable K=“” (Step S4012). Here, “i” is the number of a data block di contained in one stripe SL; in this embodiment, it can assume integral values of 1 to 4. The counter Cnt is a variable that counts the number of data blocks in which error has occurred, and the variable K is a variable that stores blocks in which error has occurred.

On the other hand, if the CPU 110 decides that redundancy code block R is not normal (Step S4011: No), since it cannot use the redundancy code block R to detect error (abnormality) occurring in a data block di, i.e. it cannot determine whether the data block di is normal, it moves to Step S4019 and terminates the processing routine.

The CPU 110 extracts the LA and LRC of the ri from the redundancy code block R (Step S4013), and decides whether the LA of the data block di matches the LA of the ri (Step S4014). In the event that the CPU 110 determines that these match (Step S4014: Yes), then decides whether the LRC calculated from the read data block di matches the LRC of the ri (Step S304). In the event that the CPU 110 decides that the LA of the data block di matches the LA of the ri (Step S4014: Yes), it then decides whether the LRC of the data block di matches the LRC of the ri (Step S4015).

In the event that the CPU 110 decides that the LRC of the data block di matches the LRC of the ri (Step S4015: Yes), it increments i by 1 (i=i+1) (Step S4016).

In the event that the CPU 110 decides that the LAof the data block di and the LA of the ri do not match (Step S4014: No), or decides that the LRC of the data block di and the LRC of the ri do not match (Step S4015: No), since an error (data corruption) has occurred in the data block di, the data block di in question is stored in the variable K, and the counter Cnt is incremented by 1 (Cnt=Cnt+1) (Step S4017). The CPU 110 determines whether the counter Cnt is smaller than 2, i.e. 0 or 1 (Step S4018), and if it determines that the counter Cnt is smaller than 2 (Step S4018: Yes), moves to Step S4016.

If on the other hand the CPU 110 determines that the counter Cnt is 2 or above (Step S4018: No), it terminates the processing routine, leaving behind error termination status (Step S4019). That is, with the RAID 5 used in this embodiment, since correction (correction) is possible for up to one error data (data corruption), correction will not be possible in the case that error data numbers 2 or more, so the process ends with an error termination.

After incrementing i by 1, the CPU 110 determines whether i=n (Step S4020). That is, it is determined whether a check has been completed for all of the data blocks di. In this embodiment, since i goes up to 4, n is defined as 5, which is equal to i+1.

If the CPU 110 decides that i≠n, that is, that checks have not been completed for all of the data blocks di (Step S4020: No), execution of Step S4103 -Step S4018 is repeated. If the CPU 110 decides that i=n, that is, that checks have been completed for all of the data blocks di (Step S4020: Yes), it checks the parity block P (Step S4021). Specifically, it is decided whether the LA and LRC stored in the parity block rP included in the redundancy code block R respectively match the LA and LRC calculated using the parity block P.

In the event that the CPU 110 decides that the parity block P is in error, i.e. that the LA and LRC stored in the parity block rP included in the redundancy code block R do not match either the calculated LA or LRC (Step S4022: No), it stores the parity block P in the variable K and increments the counter Cnt by 1 (Cnt=Cnt+1) (Step S4023). The CPU 110 determines whether the counter Cnt is smaller than 2, i.e. 0 or 1 (Step S4024), and if it determines that the counter Cnt is smaller than 2 (Step S4024: Yes), moves to Step S4025.

If on the other hand the CPU 110 determines that the counter Cnt is 2 or above (Step S4024: No), it terminates the processing routine, leaving behind error termination status (Step S4019).

In the event that the CPU 110 decides that the parity block P is normal, i.e. that the LA and LRC stored in the parity block rP match respectively the calculated LA and LRC (Step S4022: Yes), the block stored in the variable K is corrected by calculation (Step S4025), and the processing routine is terminated, leaving behind normal termination status (Step S403). In the event that an abnormal block stored in the variable K is a data block di, correction is executed using the parity block P and the other data blocks from the same stripe SL; and in the event that an abnormal block stored in the variable K is a parity block P, correction is executed using the data blocks from the same stripe SL.

As described hereinabove, according to the disk array device 10 pertaining to the second embodiment, a redundancy code block R is provided with redundancy code check codes for the redundancy code sub-blocks ri and rP, so that errors occurring in the redundancy code blocks R can be detected. Accordingly, the integrity of identification of erroneous data can be improved.

Also, the occurrence of phenomenon whereby the use of an erroneous redundancy code block R gives erroneous detection that an error has occurred in a normal data block di can be reduced or eliminated. Additionally, the event of erroneous data being returned as normal data due to an erroneous determination of normal status can be reduced or eliminated.

### Third Embodiment

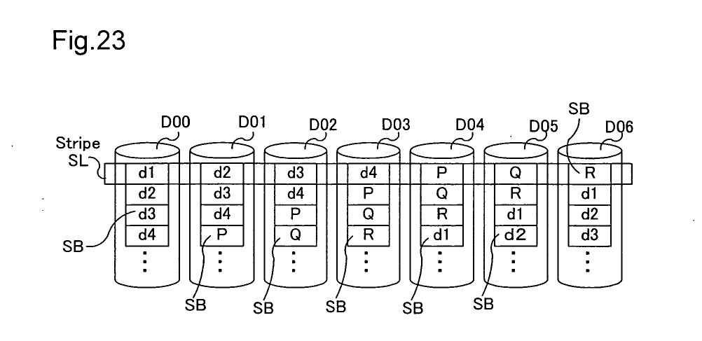

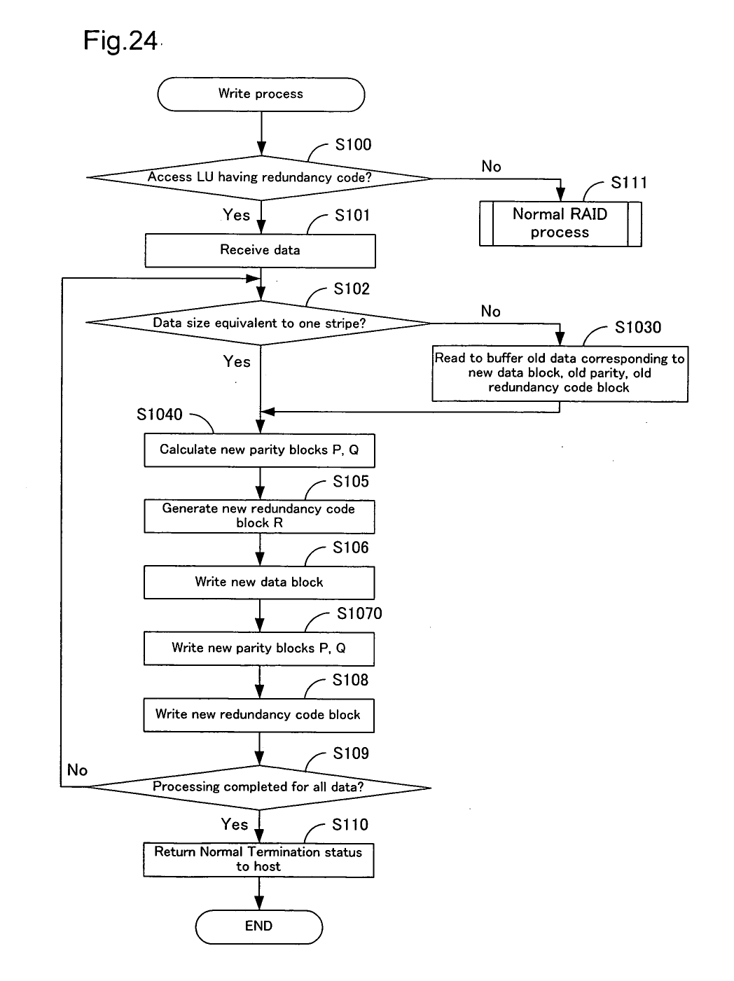

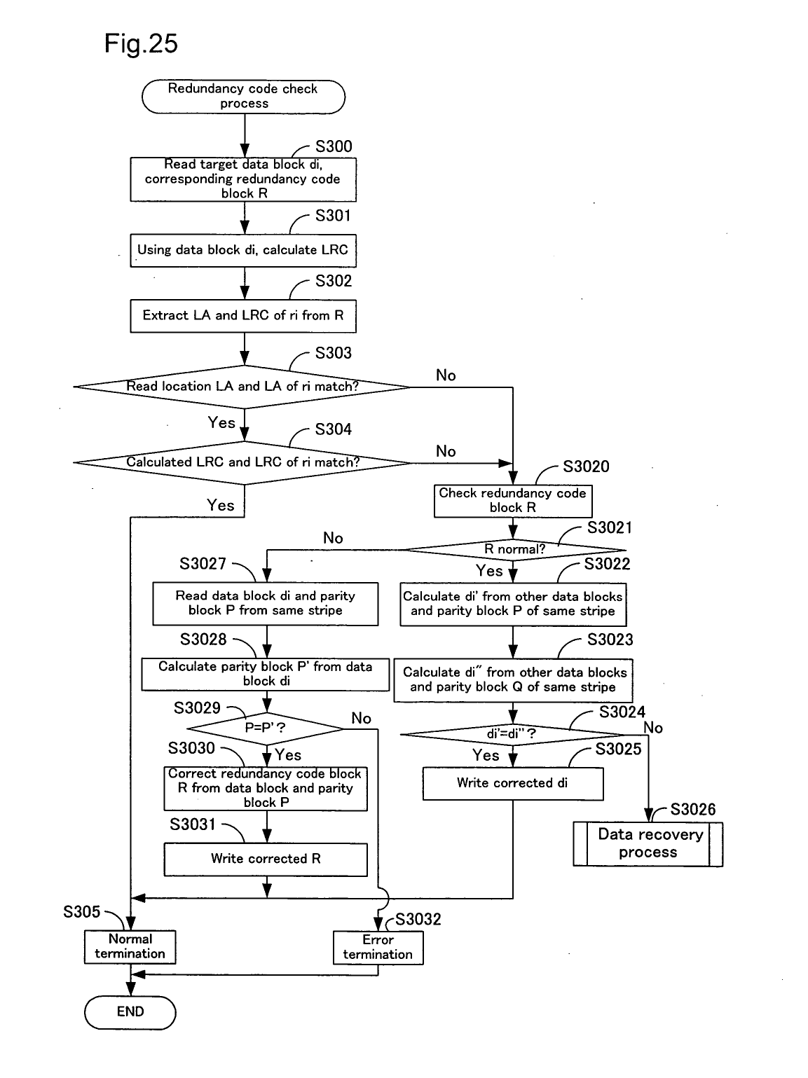

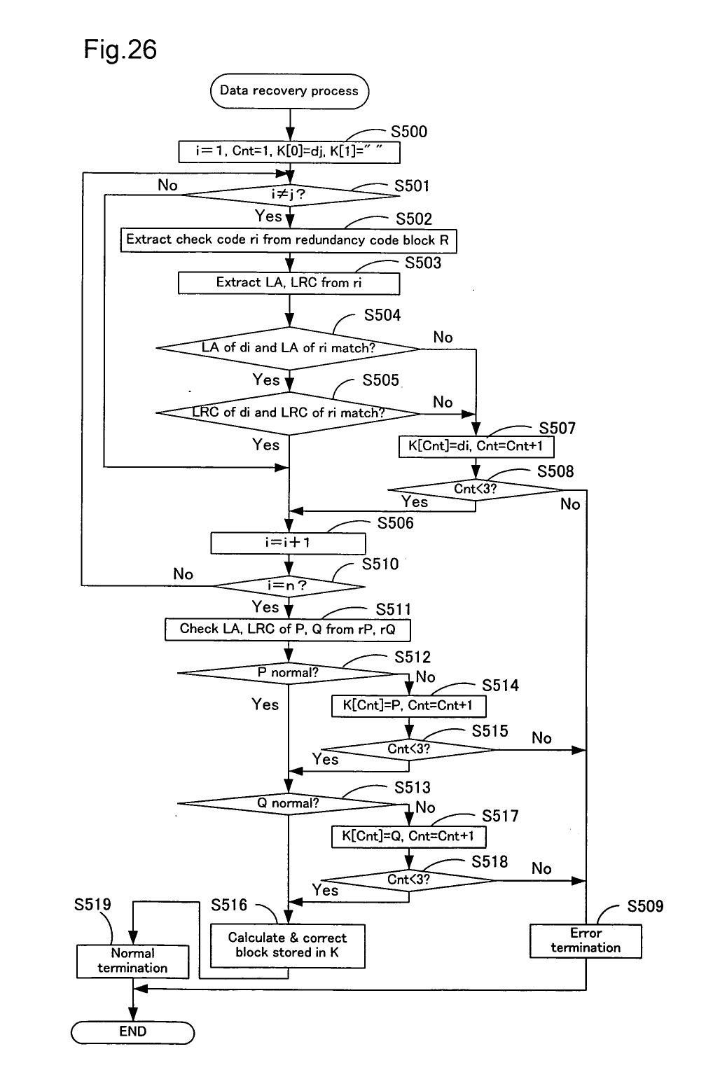

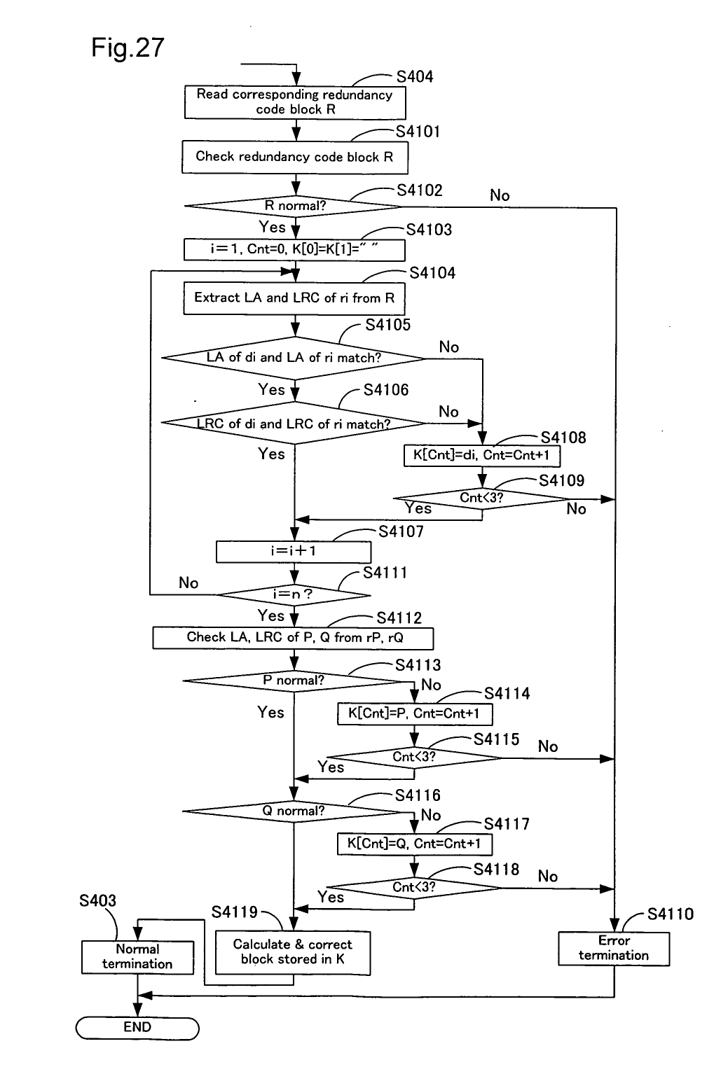

The following description of the disk array device control method pertaining to the third embodiment makes reference to FIGS. 23-27. FIG. 23 is an illustration showing the condition of storage of data blocks di, parity blocks P, and redundancy code blocks R in a plurality of disk devices making up a RAID group in the third embodiment. FIG. 24 is a flowchart showing the processing routine executed during the data write process in the disk array device pertaining to the third embodiment. FIG. 25 is a flowchart showing the processing routine executed during the redundancy code check process in the disk array device pertaining to the third embodiment. FIG. 26 is a flowchart showing the processing routine executed during the data recovery process in the disk array device pertaining to the third embodiment. FIG. 27 is a flowchart showing the processing routine executed during the parity check process in the disk array device pertaining to the third embodiment.

As shown in FIG. 23, the disk array device pertaining to the third embodiment has parity blocks P, Q stored dispersed in a plurality of disk devices, i.e. it is a so-called dual parity disk array device; it differs from the disk array device 10 pertaining to the first embodiment in that the RAID level is RAID 6. Like the second embodiment, the redundancy code blocks R contain redundancy code check codes. In other respects the arrangement of the disk array device is the same, and thus identical symbols are assigned here without any further description of disk array device arrangement.

The following description of the write process in the third embodiment makes reference to FIG. 24. The basic process flow is similar to the write process in the first embodiment, the point of difference being that the parity block Q is used in addition to the parity block P. Accordingly, the description will center on this point of difference, and for the remaining steps, the step numbers used in the description of the write process in the first embodiment will be used without any further description.

When the CPU 110 starts the processing routine, it executes Step S100 -S102 and decides whether the received data or the remaining data is equivalent to one stripe SL (Step S102).

In the event that the CPU 110 decides that the data in the cache buffer memory 117 is less than the equivalent of one stripe SL (Step S102: No), it reads into the cache buffer memory 117 old data (data blocks) corresponding to new data (data blocks), the old parity blocks Po, Qo, and the old redundancy code block Ro (Step S1030). A case in which the size of the received data is less than the equivalent of one stripe SL, or a case in which after multiple write operation a data block which is less than the equivalent of one stripe SL remains would fall into this category. The CPU 110 uses the old data block, the old parity block Po, and the new data block dn read into the cache buffer memory 117 to calculate a new parity block Pn, and uses the old data block, the old parity block Qo, and the new data block dn to calculate a new parity block Qn (Step S1040).

The CPU 110 then executes Step S105 and Step S106, writes the new parity blocks Pn, Qn to predetermined address locations of the disk devices D (Step S1070), executes Step S108-S110 and terminates the processing routine.

The following description of the redundancy code check process in the third embodiment makes reference to FIG. 25. The basic process flow is similar to the redundancy code check process in the first embodiment, the points of difference being that the parity block Q is used in addition to the parity block P, and that redundancy code check codes are used. Accordingly, the description will center on this point of difference, and for the remaining steps, the step numbers used in the description of the write process in the first embodiment will be used without any further description.

When the CPU 110 starts the processing routine, it executes Step S300-S304, and in the event that it decides that the read location LA derived by calculation does not match the LA of the ri (Step S303: No), or it decides that the LRC calculated from the read data block di does not match the LRC of the ri (Step S304: No), it checks the redundancy code sub-blocks of the redundancy code block R (Step S3020). That is, since an abnormality (error) has occurred in either the data block di or the redundancy code block R, a process to correct the error is carried out. Specifically, it is determined whether the redundancy code check code (LRC) calculated using the redundancy code sub-blocks ri (r1-r4) and rP matches the redundancy code check code (LRC) stored in the redundancy code block R.

In the event that the CPU 110 determines that the redundancy code block R is normal, i.e. that the redundancy code check code (LRC) calculated using the redundancy code sub-blocks ri (r1-r4) and rP, rQ matches the redundancy code check code (LRC) stored in the redundancy code block R (Step S3021: Yes), it calculates di′ from the parity block P and the other data blocks in the same stripe SL that includes the read data block di (Step S3022). Specifically, this is executed by means of exclusive OR of the other data blocks and parity block P.

The CPU 110 further calculates di″ from the parity block Q and the other data blocks in the same stripe SL that includes the read data block di (Step S3023). There are a number of possible methods for calculating Q, for example, Galois Field Arithmetic of the other data blocks and the parity block Q, or other logic calculation method different from the calculation format in Step S3022 (simple exclusive OR).

The CPU 110 then decides whether the data block di′ calculated using parity block P and the data block di″ calculated using parity block Q match (Step S3024), and in the event it decides that di′=di″ (Step S3024: Yes), it writes the calculated data block di′ designates as the corrected di to the corresponding address of the corresponding disk (Step S3025), and terminates the processing routine, leaving behind normal termination status (Step S305).

In the event that in Step S3024 the CPU 110 decides that di′≠di″ (Step S3024: No), it executes a data recovery process, described later (Step S3026). That is, after identifying that an error has occurred in either another data block or in parity blocks P, Q, it is necessary to correct the error.

In the event that the CPU 110 determines that the redundancy code block R is not normal (Step S3021: No), it reads the parity block P and the other data blocks of the same stripe SL (Step S3027), and calculates a parity block P′ using data blocks d1-d4 (Step S3028). The CPU 110 then decides whether the read parity block P and the calculated parity block P′ are equal (Step S3029), and if it determines that P=P′ (Step S3029: Yes), it corrects the redundancy code block R from the data block di and the parity block P (Step S3030). That is, this corresponds to a case where the read data block di is normal, and an error has occurred in the redundancy code block R. The fact that the data block di is normal may be verified by comparing the parity blocks P and P′. Correction of the redundancy code block R is carried out, specifically, by using the data blocks di and the parity block P to recalculate redundancy code sub-blocks ri, rP, and then recalculating the redundancy code check code (LRC) of the redundancy code block R by means of the ri and rP. The CPU 110 writes the corrected redundancy code block R to the corresponding address of the corresponding disk (Step S3031), and terminates the processing routine, leaving behind normal termination status (Step S305). If on other hand P and P′ are not equal (Step S3029: No), since the CPU 110 cannot identify the location of the error, i.e. whether the error is in the redundancy code block R, whether the error is in the data block di requested from the host, or whether while the data block di is correct, another data block has been read in error from the same stripe SL, it terminates the processing routine, leaving behind error termination status (Step S3032).

The following description of the data recovery process in the third embodiment makes reference to FIG. 26. Data blocks in which errors have been detected in the redundancy code check process are designated as data block dj (in this embodiment, j is an integer from 1 to 4). The CPU 110 makes the settings i=1, counter Cnt=1, variable K [0]=dj, and K [1]=“” (Step S500). Here, “i” is the number of a data block di contained in one stripe SL; in this embodiment, it can assume integral values of 1 to 4. The counter Cnt is a variable that counts the number of data blocks in which error has occurred, and the variable K is a variable that stores blocks in which error has occurred. In this embodiment, since two error data can be corrected, two are used. Since an error has already occurred in one data block, the first variable K [0]=dj, and the counter Cnt=1.

The CPU 110 decides whether i=j (Step S501), and in the event it decides that i=j (Step S501: Yes), moves on to Step S506. That is, this corresponds to a case of a data block dj in which error was detected in the preceding redundancy code check process, so that it is not necessary to execute a process to determine error of the data block di.

In the event that the CPU 110 determines that i=j (Step S501: No), it extracts the ri from the redundancy code block R (Step S502), extracts the LA and the LRC from the extracted ri (Step S503), and decides whether the LA of the data block di and the LA of the ri match (Step S504). In the event that the CPU 110 decides that the LA of the data block di matches the LA of the ri (Step S504: Yes), it then decides whether the LRC of the data block di and the LRC of the ri (Step S505).

In the event that the CPU 110 decides that the LRC of the data block di matches the LRC of the ri (Step S505: Yes), it increments i by one (=i+1) (Step S506).

In the event that the CPU 110 decides that the LA of the data block di and the LA of the ri do not match (Step S504: No), or decides that the LRC of the data block di and the LRC of the ri do not match (Step S505: No), since an error (data corruption) has occurred in the data block di, the data block di in question is stored in the variable K, and the counter Cnt is incremented by 1 (Cnt=Cnt+1) (Step S507). Here, the variable K is linked with the counter Cnt, and the value of the counter Cnt prior to being incremented is the number of the variable K. For example, in the event that error of a data block di has been detected for the first time, since the value of the counter Cnt prior to being incremented is “1” as shown in Step S500, K [1]=di. The CPU 110 determines whether the counter Cnt is smaller than 3, i.e. 0, 1 or 2 (Step S508), and if it determines that the counter Cnt is smaller than 3 (Step S508: Yes), moves to Step S506.

If on the other hand the CPU 110 determines that the counter Cnt is 3 or above (Step S508: No), it terminates the processing routine, leaving behind error termination status (Step S509). That is, with the RAID 6 used in this embodiment, since correction (correction) is possible for up to two error data (data corruption), correction will not be possible in the case that error data numbers 3 or more, so the process ends with an error termination.

After incrementing i by 1, the CPU 110 determines whether i=n (Step S510). That is, it is determined whether a check has been completed for all of the data blocks di. In this embodiment, since i goes up to 4, n is defined as 5, which is equal to i+1.

If the CPU 110 decides that i≠n, that is, that checks have not been completed for all of the data blocks di (Step S4510: No), execution of Step S501-Step S508 is repeated. If the CPU 110 decides that i=n, that is, that checks have been completed for all of the data blocks di (Step S510: Yes), it checks the parity blocks P and Q (Step S511). Specifically, it is decided whether the LA and LRC stored in the parity blocks rP, rQ included in the redundancy code block R respectively match the LA and LRC calculated using the parity blocks P, Q.

The CPU 110 decides whether the parity block P is in error (Step S512), and in the event that the CPU 110 decides that the parity block P is in error, i.e. that the LA and the LRC stored in the parity block rP included in the redundancy code block R do not match respectively the calculated LA or LRC (Step S512: No), it stores the parity block P in the variable K and increments the counter Cnt by 1 (Cnt=Cnt+1) (Step S513). The CPU 110 determines whether the counter Cnt is smaller than 3, i.e. 0, 1 or 2 (Step S514), and if it determines that the counter Cnt is smaller than 3 (Step S514: Yes), moves to Step 515.

If on the other hand the CPU 110 determines that the counter Cnt is 3 or above (Step S514: No), it terminates the processing routine, leaving behind error termination status (Step S509).

In the event that the CPU 110 decides that the parity block P is normal, i.e. that the LA and LRC stored in the parity block rP match respectively the calculated LA and LRC (Step S4022: Yes), the CPU 110 decides whether the parity block Q is in error (Step S515).

In the event that the CPU 110 decides that the parity block Q is in error, i.e. that the LA and the LRC stored in the parity block rQ do not match respectively the calculated LA or LRC (Step S515: No), it stores the parity block Q in the variable K and increments the counter Cnt by 1 (Cnt=Cnt+1) (Step S516). The CPU 110 determines whether the counter Cnt is smaller than 3, i.e. 0, 1 or 2 (Step S517), and if it determines that the counter Cnt is smaller than 3 (Step S517: Yes), moves to Step s518.

If on the other hand the CPU 110 determines that the counter Cnt is 3 or above (Step S517: No), it terminates the processing routine, leaving behind error termination status (Step S509).

In the event that the CPU 110 decides that the parity block Q is normal, i.e. that the LA and LRC stored in the redundancy code sub-block rQ match respectively the calculated LA and LRC (Step S515: Yes), it corrects by means of calculation the block stored in the variable K (Step S518), and terminates the processing routine, leaving behind normal termination status (Step S519). In the event that the abnormal block stored in the variable K is a data block di, correction is executed using the normal parity block P or Q, and the other normal blocks; in the event that the abnormal block stored in the variable K is a parity block P or Q, correction is executed using normal data blocks.

The following description of the parity check process in the third embodiment makes reference to FIG. 27. The process of Step S400-Step S404 is the same as in the parity check process of the first embodiment, and need not be described.

The CPU 110 reads the corresponding redundancy code block R (Step S404) and checks the redundancy code check code of the redundancy code block R (Step S4110). That is, the CPU 110 decides whether the redundancy code block R is normal, i.e. that the redundancy code check code (LRC) calculated using the redundancy code sub-blocks ri (r1-r4) and rP matches the redundancy code check code (LRC) stored in the redundancy code block R. If the CPU 110 decides that the redundancy code block R is normal (Step S4102: Yes), it makes the settings i=1, counter Cnt=0, variable K [0]=K [1]=“” (Step S4103). Here, “i” is the number of a data block di contained in one stripe SL; in this embodiment, it can assume integral values of 1 to 4. The counter Cnt is a variable that counts the number of data blocks in which error has occurred, and the variable K is a variable that stores data blocks in which error has occurred.

If on the other hand, the CPU 110 decides that the parity block Q is not normal (Step S4102: No), since it cannot use the redundancy code block R to detect error (abnormality) occurring in a data block di, i.e. it cannot determine whether the data block di is normal, it moves to Step S4110 and terminates the processing routine.

The CPU 110 extracts the LA and LRC of the ri from the redundancy code block R (Step S4104), and decides whether the LA of the data block di matches the LA of the ri (Step S4105). In the event that the CPU 110 decides that the LA of the data block di and the LA of the ri match (Step S4105: Yes), it then decides whether the LRC of the data block di matches the LRC of the ri (Step S4106).

In the event that the CPU 110 decides that the LRC of the data block di and the LRC of the ri match (Step S4106: Yes), it increments i by 1 (i=i+1) (Step S4107).

In the event that the CPU 110 decides that the LA of the data block di and the LA of the ri do not match (Step S4015: No), or decides that the LRC of the data block di and the LRC of the ri do not match (Step S4106: No), since an error (data corruption) has occurred in the data block di, the data block di in question is stored in the variable K, and the counter Cnt is incremented by 1 (Cnt=Cnt+1) (Step S4108). Here, the variable K is linked with the counter Cnt, and the value of the counter Cnt prior to being incremented is the number of the variable K. For example, in the event that error of a data block di has been detected for the first time, K [0]=di. The CPU 110 determines whether the counter Cnt is smaller than 3, i.e. 0, 1 or 2 (Step S4109), and if it determines that the counter Cnt is smaller than 3 (Step S4109: Yes), moves to Step S4107.

If on the other hand the CPU 110 determines that the counter Cnt is 3 or above (Step S4109: No), it terminates the processing routine, leaving behind error termination status (Step S4110). That is, with the RAID 6 used in this embodiment, since correction (correction) is possible for up to two error data (data corruption), correction will not be possible in the case that error data numbers 3 or more, so the process ends with an error termination.

After incrementing i by 1, the CPU 110 determines whether i=n (Step S4111). That is, it is determined whether a check has been completed for all of the data blocks di. In this embodiment, since i goes up to 4, n is defined as 5, which is equal to i+1.

If the CPU 110 decides that i≠n, that is, that checks have not been completed for all of the data blocks di (Step S4111: No), execution of Step S4104 -Step S4109 is repeated. If the CPU 110 decides that i=n, that is, that checks have been completed for all of the data blocks di (Step S4111: Yes), it checks the parity blocks P and Q (Step S4112). Specifically, it is decided whether the LA and LRC stored in the redundancy code sub-blocks rP, rQ included in the redundancy code block R respectively match the LA and LRC calculated using the parity blocks P, Q.

The CPU 110 decides whether the parity block P is in error (Step 10 S4113), and in the event that it decides that the parity block P is in error, i.e. that the LA and the LRC stored in the redundancy code sub-block rP do not match respectively the calculated LA and LRC (Step S4113: No), it stores the parity block P in the variable K and increments the counter Cnt by 1 (Cnt=Cnt+1) (Step S4114). In the event that an error of a data block di has been detected previously, K [1]=P, and if an error is being detected for the first time, K [0]=P. In the event that the counter Cnt prior to being incremented is 2, other abnormal blocks have already been stored in K [0], K [1], and storage of additional blocks is not possible, so this process will be ignored.

The CPU 110 determines whether the counter Cnt is smaller than 3, i.e. 0, 1 or 2 (Step S4115), and if it determines that the counter Cnt is smaller than 3 (Step S4115: Yes), moves to Step 4116.

If on the other hand the CPU 110 determines that the counter Cnt is 3 or above (Step S4115: No), it terminates the processing routine, leaving behind error termination status (Step S4110).

In the event that the CPU 110 decides that the parity block P is normal, i.e. that the LA and LRC stored in the redundancy code sub-block rP match respectively the calculated LA and LRC (Step S4113: Yes), the CPU 110 decides whether the parity block Q is in error (Step S4116). That is, it decides whether the LA and LRC stored in the redundancy code sub-block rQ match respectively the calculated LA and LRC.

In the event that the CPU 110 decides that the parity block Q is in error (Step S4116: No), it stores the parity block Q in the variable K and increments the counter Cnt by 1 (Cnt=Cnt+1) (Step S4117). In the event that the counter Cnt prior to being incremented is 2, other abnormal blocks have already been stored in K [0], K [1], and storage of additional blocks is not possible, so this process will be ignored. The CPU 110 determines whether the counter Cnt is smaller than 3, i.e. 0, 1 or 2 (Step S4118), and if it determines that the counter Cnt is smaller than 3 (Step S4118: Yes), moves to Step S4118.

If on the other hand the CPU 110 determines that the counter Cnt is 3 or above (Step S4118: No), it terminates the processing routine, leaving behind error termination status (Step S4110).

In the event that the CPU 110 decides that the parity block Q is normal, i.e. that the LA and LRC stored in the redundancy code sub-block rQ match respectively the calculated LA and LRC (Step S4116: Yes), it moves on to Step S4119. In Step S4119, the CPU 110 corrects by means of calculation the block stored in the variable K, and terminates the processing routine, leaving behind normal termination status (Step S403). In the event that the abnormal block stored in the variable K is a data block di, correction is executed using the normal parity block P or Q, and the other normal blocks; in the event that the abnormal block stored in the variable K is a parity block P or Q, correction is executed using normal data blocks.

As described above, according to the disk array device 10 pertaining to the third embodiment, in addition to the advantages deriving from the provision of redundancy code blocks R in the first embodiment, since two parity blocks P and Q are used, detection and correction (recovery) are also possible even where two errors have occurred in blocks including parity blocks.

### OTHER EMBODIMENTS

(1) In the embodiments hereinabove, the description took the examples of RAID 5 and RAID 6, but the first embodiment and the second embodiment could instead be applied to RAID 3. That is, the parity blocks P could be stored all together in one disk device D. In this case, the redundancy code blocks R could be stored all together in one disk device D, or stored distributed to a plurality of disk devices D.

(2) In the third embodiment, in addition to dual parity blocks P, Q, redundancy code sub-blocks for checking the content of the redundancy code blocks R are used, but it would of course be acceptable to,use only dual parity blocks P, Q. In this case as well, errors occurring in two blocks can be detected and corrected. The parity blocks P and/or Q could be stored all together in one disk device D. The redundancy code blocks R could be stored all together in one disk device D, or stored distributed to a plurality of disk devices D.

(3) In the embodiments hereinabove, the disk array device control processes are executed by a control program (execution modules), but could instead be executed using hardware circuits comprising logic circuits for executing the aforementioned processes (steps). In this case, the load on the CPU 110 could be reduced, and faster control processes achieved. The control process hardware circuits could be installed in the disk array controllers 11, 12, for example.

While the disk array device, disk array device control method, and disk array device control program pertaining to the invention have been described herein on the basis of embodiments, the embodiments of the invention set forth hereinabove are intended to facilitate understanding of the invention, and should not be construed as limiting thereof. Various modifications and improvements to the invention are possible without departing from the sprit thereof, and these equivalents are included within the scope of the invention.

What is claimed is:

1. A disk array device for distributed management of data in a plurality of disk devices, the disk array device comprising:
a data sending/receiving module for sending and receiving data;
a plurality of disk devices having fixed sector length, wherein the plurality of disk devices stores data and redundancy information for securing contents and data store location respectively in different disk devices; and
an access control module for executing data and information read/write operations to and from said disk devices.

2. A disk array device according to claim 1, wherein disk devices making up said disk array device each have a plurality of storage areas of identical size for storing said data or information, with storage areas in said disk devices constituting unit storage sequences for storing redundancy information.

3. A disk array device according to claim 2, wherein
said redundancy information includes storage unit data consisting of data stored in one storage area of said disk devices, and a plurality of redundancy data relating to attributes of the storage unit data; and
said plurality of disk devices further stores error detection/correction information including redundancy data based on said storage unit data to be included in said unit storage sequences, in a different disk device from said data and said redundancy information.

4. A disk array device according to claim 3 further comprising:
a command interpreting module for interpreting commands received from an external host computer;
a data sending/receiving module for sending and receiving data to and from an external host computer;
a storage unit data generating module that, in the event that a said interpreted command is a write command, uses data received by said data sending/receiving module, to generate a plurality of said storage items data for storing the received data in a dispersed arrangement in memory areas of said disk devices;
an error detection/correction information generating module that uses said storage unit data included in said unit storage sequences, to generate said error detection/correction information; and
a redundancy information generating module that uses said storage unit data stored in said one storage area of said disk devices, to generate redundancy information;
wherein said access control module writes said generated unit storage information and error detection/correction information to said storage areas of said disk devices.

5. A disk array device according to claim 4, wherein
in the event that said interpreted command is a read command, and the read unit of data requested by said external host computer is not a read unit having said storage unit sequence as the unit,
said access control module reads from said plurality of disk devices storage unit data corresponding to said requested data; and
said disk array device further comprises:
a first decision module that uses said read storage unit data and said redundancy information corresponding to said read storage unit data, to decide whether an error has occurred in said read storage unit data or said redundancy information; and
a first correction module that, in the event of a decision that an error has occurred in said read storage unit data or said redundancy information, corrects the error that has occurred in said read storage unit data or said redundancy information.

6. A disk array device according to claim 5, wherein
said redundancy information includes data redundancy information for checking the integrity of storage unit data stored in said first storage area, and location redundancy information for checking the integrity of the location to which said storage unit has been written in a said disk device,
said first decision module, in the event that either data redundancy information calculated using said read storage unit data and said read location redundancy information of storage unit data, or location redundancy information and said data redundancy information of said redundancy information do not match, decides that an error has occurred in said read storage unit data or said redundancy information, and
said first correction module, using all other storage unit data included in the storage unit sequence to which said read storage unit data belongs, and said error detection/correction information, corrects said read storage unit data, and uses said generated storage unit data to correct said redundancy information.

7. A disk array device according to claim 4, wherein
in the event that said interpreted command is a read command, and the read unit of data requested by said external host computer is a read unit having said storage unit sequence as the unit,
said access control module reads from said plurality of disk devices said storage unit sequence that contains storage unit data corresponding to said requested data; and
said disk array device further comprises:
a second decision module that uses said storage unit data and said error detection/correction information contained in said read storage unit sequence, to decide whether an error has occurred in said error detection/correction information or storage unit data contained in said read storage unit sequence; and
a second correction module that, in the event of a decision that an error has occurred in said error detection/correction information or storage unit data contained in said read storage unit sequence, corrects the error that has occurred in said error detection/correction information or storage unit data contained in said read storage unit sequence.

8. A disk array device according to claim 7 further comprising:
an error identifying module that, in the event of a decision that an error has occurred in said error detection/correction information or storage unit data contained in said read storage unit sequence, uses said redundancy information to identify whether the error has occurred in said error detection/correction information or in storage unit data contained in said read storage unit sequence,
wherein said second correction module, in the event that the error is identified as having occurring said read storage unit data, uses all other storage unit data included in the storage unit sequence to which said read storage unit data belongs, and said error detection/correction information, to correct said error detection/correction information.

9. A disk array device according to claim 8, wherein
said second correction module, in the event that the error is identified as having occurred in said error detection/correction information, uses said storage unit data included in the same storage unit sequence as said error detection/correction information, to correct said error detection/correction information.

10. A disk array device according to claim 1, wherein
said error detection/correction information is parity information calculated using all of said disk array device included in said storage unit sequence.

11. A disk array device according to claim 1, wherein
said redundancy information includes data redundancy information for checking the integrity of storage unit data stored in said first storage area, and location redundancy information for checking the integrity of the storage location of said storage unit data in a said disk device.

12. A disk array device according to claim 11, wherein
said data redundancy information is vertical or lateral parity information calculated using storage unit data stored in said storage areas,
and
said location redundancy information is address information for writing said storage unit data to a desired location in a said disk device.

13. A disk array device according to claim 1, wherein
said error detection/correction information in its entirety is stored in one disk device making up said plurality of disk devices, and
said redundancy information in its entirety is stored in one other disk device making up said plurality of disk devices.

14. A disk array device according to claim 1, wherein
said error detection/correction information, like said storage unit data, is stored dispersed in said plurality of disk devices.

15. A disk array device according to claim 14, wherein
said redundancy information, like said storage unit data, is stored dispersed in said plurality of disk devices.

16. A disk array device according to claim 1, wherein
said redundancy information, like said storage unit data, is stored dispersed in said plurality of disk devices.

17. A disk array device according to claim 16, wherein
said error detection/correction information, like said storage unit data, is stored dispersed in said plurality of disk devices.

18. A disk array device according to claim 11, wherein
said redundancy information further has second data redundancy information for detecting error of redundancy information; and
said disk array device further comprises a second identifying module that uses said second data redundancy information to identify whether error has occurred in either said redundancy information or in said read storage unit data.

19. A disk array device according to claim 1, wherein
an administration device is connected to said disk array device, and
said administration device comprises a conferring module for conferring said redundancy information to said plurality of disk devices; and
an indicator for showing whether redundancy information has been conferred to said plurality of disk devices

20. A disk array device for distributed writing of data to N (where N is 4 or a greater natural number) of disk devices having fixed sector length, the disk array device comprising:
a data sending/receiving module for sending and receiving data;
a write storage unit data generating module for generating storage unit data of predetermined distribution size using data received by said data sending/receiving module;
a first error correction information generating module for generating first error correction information using write data for writing to N-2 said disk devices from among said generated storage unit data;
a second error correction information generating module for generating second error correction information using storage unit data written respectively to said N-2 disk devices, and attributes of said storage unit data; and
a write module for writing said storage unit data and said first and second error correction information separately to said plurality of disk devices.

21. A method of controlling a disk array device for distributed management of a plurality of disk devices composed of disk devices having a plurality of storage areas of the same given size, the method of controlling a disk array device comprising:
using data received from an external host computer to generate a plurality of storage unit data for distributed storage in storage areas of said disk devices;
using said storage unit data which is included in a unit storage sequence formed by storage areas of disk devices making up said plurality of disk devices, to generate error detection/correction information; using said unit storage data stored in said one storage area in a said disk device and attributes of the unit storage data to generate redundancy information; and
writing said generated unit storage data, error detection/correction information, and redundancy information separately to said memory area of said disk devices making up said unit storage sequence.
